(19) United States
(12) Patent Application Publication
(10) Pub. No.: US 2026/0022481 A1
(43) Pub. Date: Jan. 22, 2026

(54) COMPOSITE ANION EXCHANGE MEMBRANE AND CATALYST COATED MEMBRANE FOR ELECTROCHEMICAL DEVICES

(71) Applicant: UOP LLC, Des Plaines, IL (US)

(72) Inventors: Chunqing Liu, Arlington Heights, IL (US); Nicole Karns, Des Plaines, IL (US); Saad Intikhab, Lombard, IL (US); Stacey Deptuch, Norhfield, IL (US); Xueliang Dong, Schaumburg, IL (US); Shurong Yang, Naperville, IL (US)

(21) Appl. No.: 18/775,222

(22) Filed: Jul. 17, 2024

(51) Int. Cl. C25B 13/08; C25B 9/23; C25B 11/032; C25B 11/053; C25B 11/054; C25B 11/059; C25B 11/081; H01M 4/88; H01M 4/92; H01M 8/1004; H01M 8/103

(52) U.S. Cl. CPC C25B 13/08; C25B 9/23; C25B 11/032; C25B 11/053; C25B 11/054; C25B 11/059; C25B 11/081; H01M 4/8807; H01M 4/881; H01M 4/92; H01M 4/926; H01M 8/1004; H01M 8/103

(57) ABSTRACT

Composite anion exchange membranes are described. The composite anion exchange membranes comprise an anion exchange polymer containing a hydrogen recombination catalyst dispersed in the anion exchange polymer. The anion exchange membrane may also include a radical scavenger. The anion exchange polymer comprises a plurality of repeating units of formula (I)

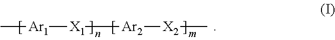

Catalyst coated membranes and membrane electrode assemblies made using the composite anion exchange membranes are also described.

### BACKGROUND

Hydrogen as an energy vector for grid balancing or power-to-gas and power-to-liquid processes plays an important role in the path toward a low-carbon energy structure that is environmentally friendly. Water electrolysis produces high quality hydrogen by electrochemical splitting of water into hydrogen and oxygen; the reaction is given by Eq. 1 below. The water electrolysis process is an endothermic process and electricity is the energy source. Water electrolysis has zero carbon footprint when the process is operated by renewable power sources, such as wind, solar, or geothermal energy. The main water electrolysis technologies include alkaline electrolysis, proton exchange membrane (PEM) water electrolysis (PEMWE as shown in FIG. 1), anion exchange membrane (AEM) water electrolysis (AEMWE as shown in FIG. 2), and solid oxide water electrolysis.

As shown in FIG. 1, in a PEMWE system 100, an anode 105 and a cathode 110 are separated by a solid PEM electrolyte 115 such as a sulfonated tetrafluoroethylene based cofluoropolymer sold under the trademark Nafion® by Chemours company. The anode and cathode catalysts typically comprise IrO₂ and Pt, respectively. At the positively charged anode 105, pure water 120 is oxidized to produce oxygen gas 125, electrons (e⁻), and protons; the reaction is given by Eq. 2. The protons are transported from the anode 105 to the cathode 110 through the PEM 115 that conducts protons. At the negatively charged cathode 110, a reduction reaction takes place with electrons from the cathode 110 being given to protons to form hydrogen gas 130; the reaction is given by Eq. 3. The PEM 115 not only conducts protons from the anode 105 to the cathode 110, but also separates the H₂ gas 130 and O₂ gas 125 produced in the water electrolysis reaction. PEM water electrolysis is one of the favorable methods for conversion of renewable energy to high purity hydrogen with the advantage of compact system design at high differential pressures, high current density, high efficiency, fast response, small footprint, lower temperature (20-90° C.) operation, and high purity oxygen byproduct. However, one of the major challenges for PEM water electrolysis is the high capital cost of the cell stack comprising expensive acid-tolerant stack hardware such as the Pt-coated Ti bipolar plates, expensive noble metal catalysts required for the electrodes, as well as the expensive PEM.

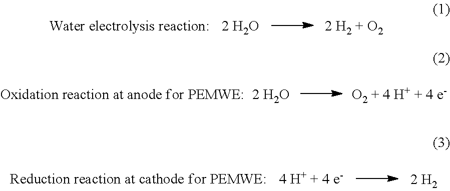

AEMWE is a developing technology. As shown in FIG. 2, in the AEMWE system 200, an anode 205 and a cathode 210 are separated by a solid AEM electrolyte 215. Typically, a water feed 220 with an added electrolyte such as dilute KOH or K₂CO₃ or a deionized water is fed to the cathode side. The anode and cathode catalysts typically comprise platinum metal-free Ni-based or Ni alloy catalysts. At the negatively charged cathode 210, water is reduced to form hydrogen 225 and hydroxyl (OH⁻) ions by the addition of four electrons; the reaction is given by Eq. 4. The hydroxyl ions diffuse from the cathode 210 to the anode 205 through the AEM 215 which conducts hydroxyl ions. At the positively charged anode 205, the hydroxyl ions recombine as water and oxygen 230; the reaction is given by Eq. 5. The AEM 215 not only conducts hydroxyl ions from the cathode 210 to the anode 205, but also separates the H₂ 225 and O₂ 230 produced in the water electrolysis reaction. The AEM 215 allows the hydrogen 225 to be produced under high pressure up to about 35 bar with very high purity of at least 99.9%.

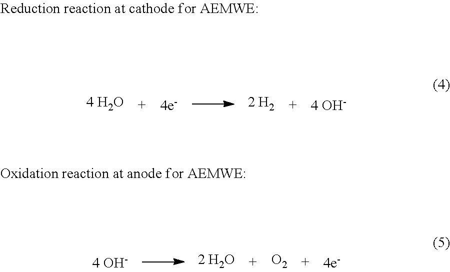

AEMWE has an advantage over PEMWE because it permits the use of less expensive platinum group metal-free catalysts, such as Ni and Ni alloy catalysts. In addition, much cheaper stainless steel bipolar plates can be used in the gas diffusion layers (GDL) for AEMWE, instead of the expensive Pt-coated Ti bipolar plates currently used in PEMWE. However, the largest impediments to the development of AEM systems are the hydroxyl ion conductivity and stability of the AEM, as well as high H₂ crossover. Research on AEMWE in the literature has been focused on developing electrocatalysts, anion exchange polymers and membranes, and understanding the operational mechanisms with the general objective of obtaining a high efficiency, low cost and stable AEMWE technology.

Fuel cells, as a next generation clean energy resource, convert the energy of chemical reactions such as an oxidation/reduction redox reaction of hydrogen and oxygen into electric energy. The three main types of fuel cells are alkaline electrolyte fuel cells, polymer electrolyte membrane fuel cells, and solid oxide fuel cells. Polymer electrolyte membrane fuel cells may include proton exchange membrane fuel cells (PEMFC), anion exchange membrane fuel cells (AEMFC), and direct methanol fuel cells. PEMFC uses a PEM to conduct protons from the anode to the cathode, and it also separates the H₂ and O₂ gases to prevent gas crossover. AEMFC uses an AEM to conduct OH⁻ from the cathode to the anode, and it also separates the H₂ and O₂ gases to prevent gas crossover.

The anode in an electrochemical cell is the electrode at which the predominant reaction is oxidation (e.g., the water oxidation/oxygen evolution reaction electrode for a water electrolyzer, or the hydrogen oxidation electrode for a fuel cell). The cathode in an electrochemical cell is the electrode at which the predominant reaction is reduction (e.g., the proton reduction/hydrogen evolution reaction electrode for a water electrolyzer, or the oxygen reduction electrode for a fuel cell). The membrane is one of the key materials that make up an electrolysis cell or a fuel cell and is an important driver for safety and performance. Some important properties for membranes for fuel cells and membrane electrolysis include high conductivity, high ionic permeability, high ionic exchange capacity (for ion-exchange membrane), high ionic/H₂ and O₂ selectivity (low H₂ and O₂ permeability/crossover), low price, low area resistance to minimize efficiency loss resulting from ohmic polarization, high resistance to oxidizing and reducing conditions, being chemically inert at a wide pH range, high thermal stability together with high proton conductivity, and high mechanical strength (thickness, low swelling).

Significant advances are needed in cost-effective, high performance membrane materials to improve the efficiency and reduce the cost of water electrolyzers, such as the design of the catalyst-coated membranes (CCMs) with low H₂ crossover.

### BRIEF DESCRIPTION OF THE DRAWINGS

FIG. 1 is an illustration of one embodiment of a PEMWE cell.

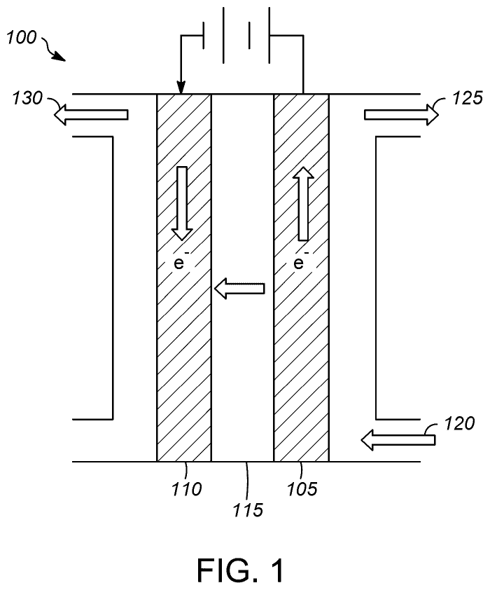

FIG. 2 is an illustration of one embodiment of a AEMWE cell.

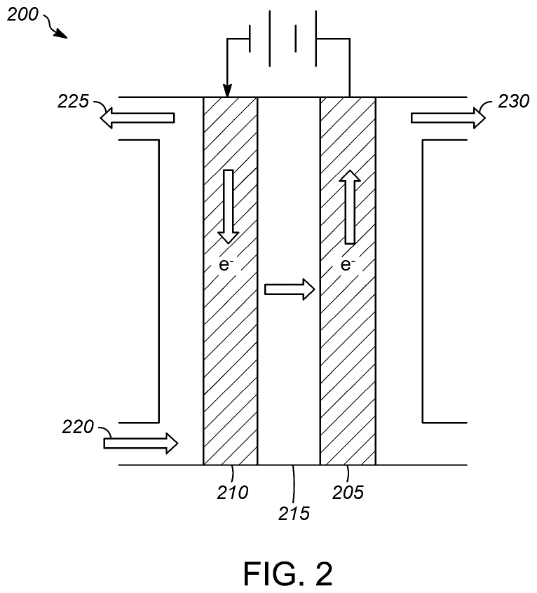

FIG. 3 is an illustration of one embodiment of a composite anion exchange membrane and a membrane electrode assembly comprising the composite anion exchange membrane of the present invention.

FIG. 4 is a graph showing the polarization curves of a water electrolysis cell comprising (a) Pt-C/PTPPB-PTPP/Pt/CeO₂ CCM and (b) Pt-C/PTPPB-PTPP CCM made according to the present invention.

### DESCRIPTION OF THE INVENTION

Novel composite anion exchange membranes and catalyst coated membranes (CCM) comprising the composite anion exchange membranes for electrolysis, fuel cell, energy storage, and other electrochemical applications have been developed. The H₂ in O₂ content at the anode of the water electrolyzer can be significantly reduced by incorporating the composite anion exchange membrane comprising H₂ recombination catalysts such as Pt particles and optionally a radical scavenger such as CeO₂ into the CCM. The permeating H₂ and O₂ forms H₂O inside the membrane catalyzed by the H₂ recombination catalysts, leading to higher O₂ byproduct gas purity at the anode of the AEM electrolyzer and resolving safety issues. The radical scavenger improves the membrane chemical/electrochemical stability.

The new type of composite anion exchange membrane comprising H₂ recombination catalysts, including, but not limited to, Pt, Pt supported on carbon, silica, titania, or zirconia, PtCo, PtCo supported on carbon, silica, titania, or zirconia, Pd, Pd supported on carbon, silica, titania, or zirconia, PdCo, PdCo supported on carbon, silica, titania, or zirconia, Ru, Ru supported on carbon, silica, titania, or zirconia, RuCo, RuCo supported on carbon, silica, titania, or zirconia, or mixtures thereof. The composite anion exchange membrane may optionally include a radical scavenger, including, but not limited to, CeO₂, Ce(OH)₄, NbO₂, NbO, CeO₂/ZrO₂, CeO₂/NbO₂, TiO₂, HfO₂, Bi₂O₃, BeO, Ta₂O₅, Ce(OH)₄/ZrO₂, CeO₂—TiC, MnO, MnO₂, MnO₂/SiO₂—SO₃H, boehmite, silica-supported Cr, Co or Mn, or mixtures thereof.

A CCM comprising the composite anion exchange membrane can be prepared by dispersing the H₂ recombination catalysts, such as Pt particles, and optionally a radical scavenger, such as CeO₂, in the anion exchange polymer coating solution to form a composite anion exchange polymer coating solution using high shear mixing and ultrasonication. A thin layer of the composite anion exchange polymer coating solution is coated on one surface of a supporting substrate using any suitable coating methods, for example, knife-coating, Mayer rod-coating, slot-die-coating, gravure coating, inkjet printing, screen printing, curtain printing, spray coating, and the like. The supporting substrate is insoluble in the composite anion exchange polymer coating solution and can be made from any suitable polymer material. Suitable polymer materials include, but are not limited to, polyester such as polyethylene terephthalate (PET), polyimide, poly (ether ether ketone) (PEEK), polyphenylene sulfide (PPS), polytetrafluoroethylene (PTFE), perfluoroalkoxy polymer, fluorinated ethylene propylene, polyolefins such as polyethylene (PE), polypropylene (PP), and copolymers of PE and PP, copolymers of tetrafluoroethylene and ethylene, copolymers of tetrafluoroethylene and propylene, polychlorotrifluoroethylene, copolymers of chlorotrifluoroethylene and vinylidene fluoride, copolymers of chlorotrifluoroethylene and ethylene, or combinations thereof. The coated layer is dried to evaporate the solvents and form the composite anion exchange membrane. The drying can be done at any suitable temperature including, but not limited to, at 50° C. to 150° C., or at 50° C. to 120° C., or at 80° C. to 120° C.

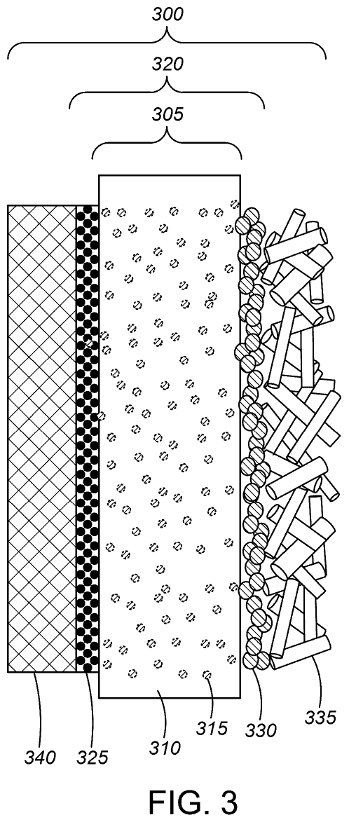

As shown in FIG. 3, the membrane electrode assembly 300 for AEMWE comprises the composite AEM 305. The composite AEM 305 comprises an anion exchange polymer 310 containing hydrogen recombination catalyst 315 dispersed in the anion exchange polymer 310. Any suitable hydrogen recombination catalyst can be used. Suitable hydrogen recombination catalysts include, but are not limited to, Pt, Pt supported on carbon, silica, titania, or zirconia, PtCo, PtCo supported on carbon, silica, titania, or zirconia, Pd, Pd supported on carbon, silica, titania, or zirconia, PdCo, PdCo supported on carbon, silica, titania, or zirconia, Ru, Ru supported on carbon, silica, titania, or zirconia, RuCo, RuCo supported on carbon, silica, titania, or zirconia, or mixtures thereof.

The composite AEM 305 may optionally include a radical scavenger (not shown). Any suitable radical scavenger can be used. Suitable radical scavengers include, but are not limited to, CeO₂, Ce(OH)₄, NbO₂, NbO, CeO₂/ZrO₂, CeO₂/NbO₂, TiO₂, HfO₂, Bi₂O₃, BeO, Ta₂O₅, Ce(OH)₄/ZrO₂, CeO₂—TiC, MnO, MnO₂, MnO₂/SiO₂—SO₃H, boehmite, silica-supported Cr, Co or Mn, or mixtures thereof. The catalytic H₂ recombination reaction in the composite AEM 305 and the catalytic reactions in the cathode catalyst layer 325 as shown in in FIG. 3 in the presence of O₂ generate hydrogen peroxide and radical intermediates, such as hydroperoxyl (HOO^{·}) and hydroxyl (HO^{·}) radicals. These reactive oxygen species result in membrane and ionomer degradation. The incorporation of the radical scavenger in the composite AEM 305 provides improved durability of the membrane.

The catalyst coated membrane 320 can be made by coating a thin layer of anode catalyst ink 330 on one surface and a thin layer of cathode catalyst ink 325 on the other surface of the composite AEM 305. The anode catalyst ink layer 330 and the cathode catalyst ink layer 325 are dried to form the catalyst coated membrane 320 comprising the composite AEM 305, an anode catalyst layer 330 and a cathode catalyst layer 325. The anode catalyst ink layer and the cathode catalyst ink layer can be dried at any suitable temperature including, but not limited to, at about 30° C. to about 150° C., or at about 30° C. to about 120° C., or at about 40° C. to 120° C.

In some embodiments, the anode and the cathode catalysts in the anode catalyst layer 330 and the cathode catalyst layer 325 are platinum group metal (PGM) electrocatalysts or PGM-free electrocatalysts. The anode and the cathode catalysts are for oxygen evolution reaction and hydrogen evolution reaction, respectively. The anode and the cathode catalysts should have good electrical conductivity, and good electrocatalytic activity and stability. Suitable PGM cathode catalysts can be selected from, but are not limited to, platinum, ruthenium, osmium, rhodium, palladium, alloys thereof, oxides thereof, carbides thereof, phosphides thereof, their supported catalysts, or combinations thereof. Suitable PGM anode catalysts can be selected from, but are not limited to, iridium, platinum, ruthenium, osmium, rhodium, palladium, alloys thereof, oxides thereof, carbides thereof, phosphides thereof, their supported catalysts, or combinations thereof. Suitable PGM-free cathode catalysts can be selected from, but are not limited to, tin, tungsten, vanadium, cobalt, silver, gold, copper, nickel, molybdenum, iron, chromium, Ni-based alloys such as Ni—Mo, Ni—Al, Ni—Cr, Ni—Sn, Ni—Co, Ni—W, and Ni—Al—Mo, metal carbides such as Mo₂C, metal phosphides such as CoP, metal dichalcogenides such as MoSe₂, and mixtures thereof. Suitable PGM-free anode catalysts can be selected from, but are not limited to, tin, tungsten, vanadium, cobalt, silver, gold, copper, nickel, molybdenum, iron, chromium, Ni—Fe alloy, Ni—Mo alloy, spinel CuₓCo₃ₓO₃, Ni—Fe layered double hydroxides, Ni—Fe layered double hydroxides on carbon nanotubes, immobilized metal catalyst on conductive supports, Ni—Fe—W—B layered double hydroxides, Ni—Fe—W—B layered double hydroxides supported on carbon nanotubes, immobilized metal catalyst on conductive supports, Ni—Fe—Ce—B layered double hydroxides, Ni—Fe—Ce—B layered double hydroxides supported on carbon nanotubes, immobilized metal catalyst on conductive supports, and mixtures thereof.

An anode porous transport layer 335 and cathode porous transport layer 340 are positioned on the anode catalyst layer 330 and the cathode catalyst layer 325, respectively to form the membrane electrode assembly 300. The anode porous transport layer 335 and the cathode porous transport layer 340 simultaneously transport electrons, heat, and products with minimum voltage, current, thermal, interfacial, and fluidic losses. The cathode porous transport layer 340 can be made from, but is not limited to, stainless steel, nickel meshes, nickel forms, titanium meshes, titanium felts, titanium foams, or carbon-based materials such as non-woven carbon paper, non-woven carbon cloth, or woven carbon cloth. The anode porous transport layer 335 can be made from, but is not limited to, stainless steel, nickel meshes, nickel forms, titanium meshes, titanium felts, or titanium foams.

The elimination or mitigation of the indirect energy losses arising from gas crossover in the electrolyzers would provide significant energy savings for water electrolysis. Gas permeation through the water electrolyzer will lead to H₂ in O₂ at the anode side of the electrolyzer, which causes a safety hazard and the reduction of the electrolyzer efficiency. The composite AEM in the present invention effectively lowered the H₂ crossover from the cathode stream to the anode stream and prevented the formation of an explosive H₂/O₂ mixture in the anode stream. The H₂ recombination reaction of H₂ and O₂ in the composite AEM results in the formation of water and therefore lowers the H₂ concentration in O₂ in the anode stream.

One aspect of the invention is an anion exchange membrane. In one embodiment, the anion exchange membrane comprises: an anion exchange polymer; and a hydrogen recombination catalyst dispersed in the anion exchange polymer; wherein the anion exchange polymer comprises a plurality of repeating units of formula (I)

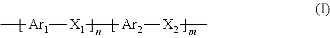

wherein Ar₁ and Ar₂ are independently selected from the group consisting of:

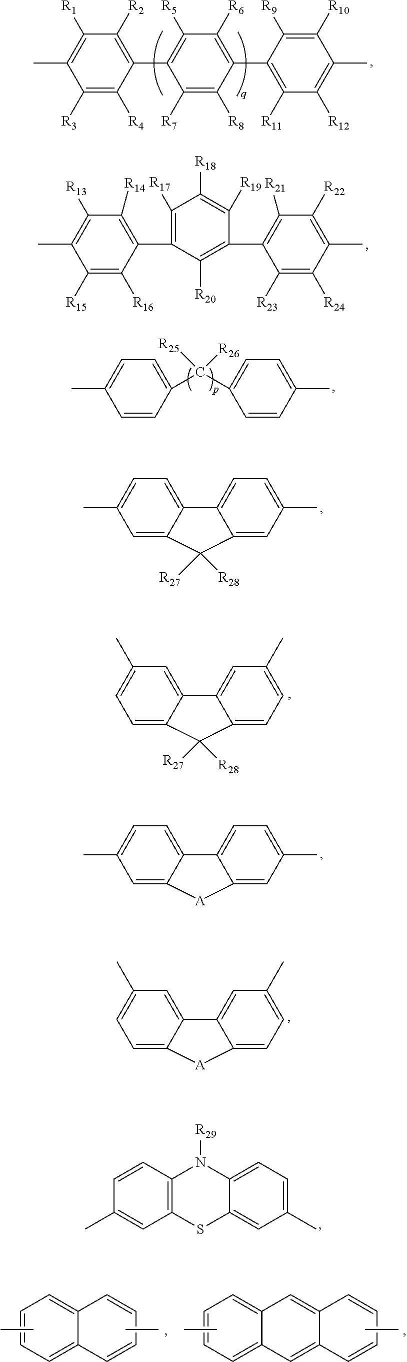

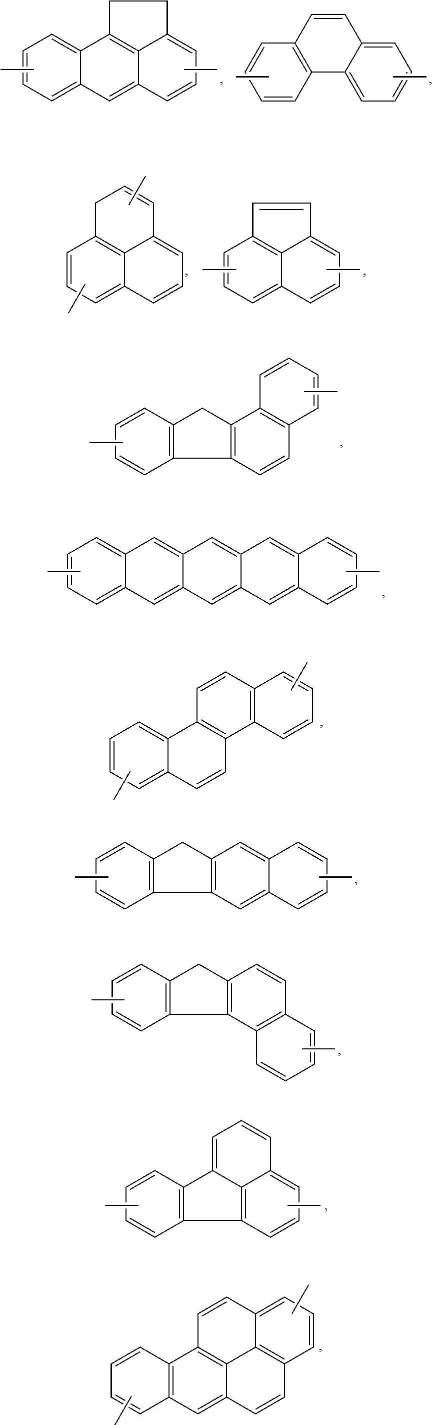

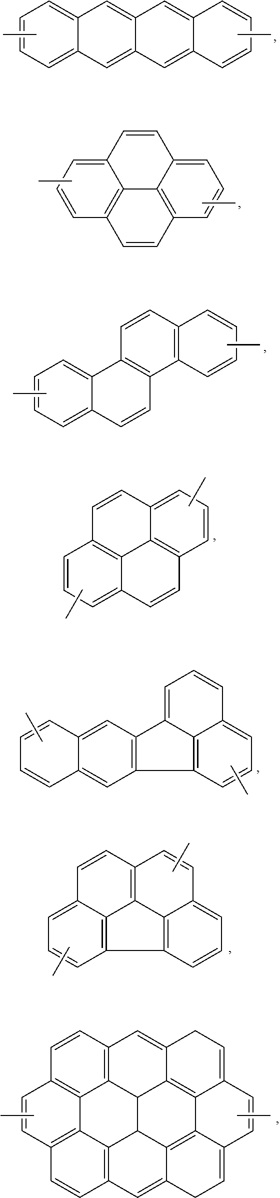

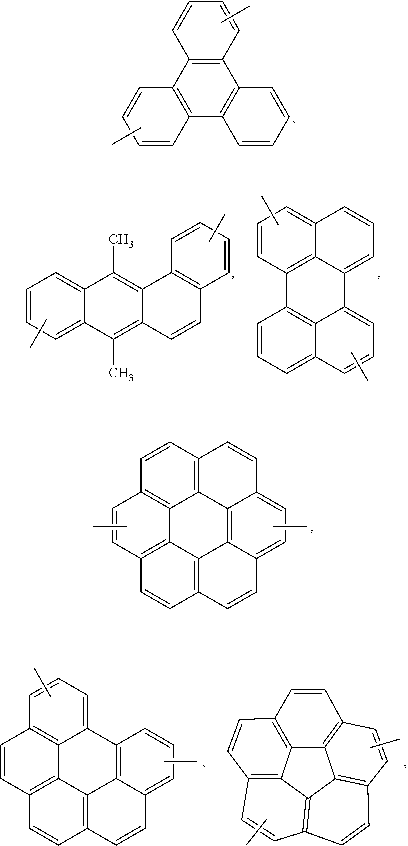

and mixtures thereof;

wherein X₁ is selected from the group consisting of:

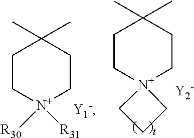

and mixtures thereof;

wherein X₂ is selected from the group consisting of:

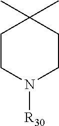

or a mixture of

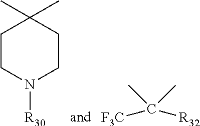

wherein Ar₁ and Ar₂ are the same or different from each other;

wherein Y₁⁻ and Y₂⁻ are anions;

wherein R₁-R₂₈ are each independently hydrogen, a halide, an alkyl group, an alkenyl group, an alkynyl group, or an aryl group, and the alkyl, alkenyl, alkynyl, or aryl groups are optionally substituted with a halide or a positively charged functional group;

wherein R₂₉-R₃₁ are each independently hydrogen, an alkyl group, an alkenyl group, an alkynyl group, or an aryl group, and the alkyl, alkenyl, alkynyl or aryl groups are optionally substituted with a halide or a positively charged functional group;

wherein R₃₂ is an alkyl group, an alkenyl group, an alkynyl group, or an aryl group, and the alkyl, alkenyl, alkynyl or aryl group is optionally substituted with a halide or a positively charged functional group;

wherein A is O, S, or NR₁₀₀;

wherein R₁₀₀ is hydrogen, an alkyl group, an alkenyl group, an alkynyl group, or an aryl group, and the alkyl, alkenyl, alkynyl, or aryl groups are optionally substituted with a halide or a positively charged functional group;

wherein n is an integer from 10 to 100,000;

wherein m is an integer from 5 to 50,000 and the molar ratio of n/m is in a range of 1:1 to 99:1;

wherein p is 1, 2, 3, or 4;

wherein q is 0, 1, 2, or 3; and

wherein t is 1, 2, 3, 4, 5, or 6.

In some embodiments, the hydrogen recombination catalyst comprises Pt, Pt supported on carbon, silica, titania, or zirconia, PtCo, PtCo supported on carbon, silica, titania, or zirconia, Pd, Pd supported on carbon, silica, titania, or zirconia, PdCo, PdCo supported on carbon, silica, titania, or zirconia, Ru, Ru supported on carbon, silica, titania, or zirconia, RuCo, RuCo supported on carbon, silica, titania, or zirconia, or mixtures thereof. In some embodiments, the anion exchange membrane further comprises a radical scavenger. Any suitable radical scavenger can be used. Suitable radical scavengers include, but are not limited to, CeO₂, Ce(OH)₄, NbO₂, NbO, CeO₂/ZrO₂, CeO₂/NbO₂, TiO₂, HfO₂, Bi₂O₃, BeO, Ta₂O₅, Ce(OH)₄/ZrO₂, CeO₂—TiC, MnO, MnO₂, MnO₂/SiO₂—SO₃H, boehmite, silica-supported Cr, Co or Mn, or mixtures thereof.

In some embodiments, Ar₁ and Ar₂ are independently selected from the group consisting of

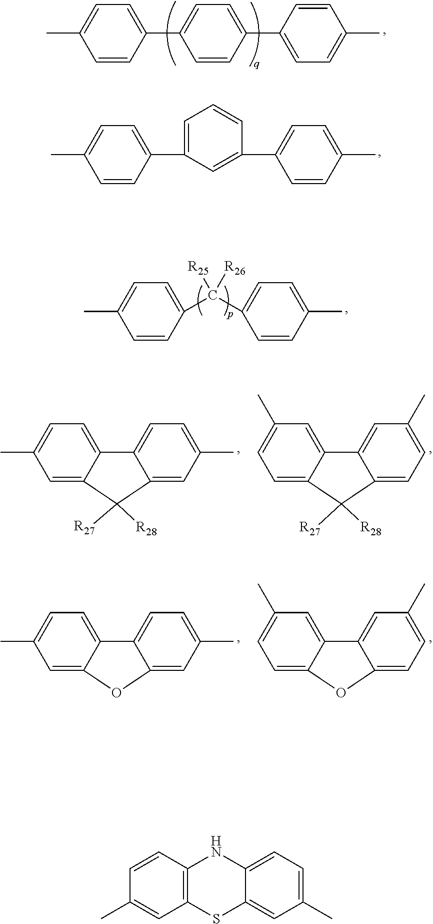

and mixtures thereof;

wherein R₂₅, R₂₆, R₂₇, and R₂₈ are each independently —H or —CH₃;

wherein p is 1 or 2; and

wherein q is 0 or 1.

In some embodiments, Ar₁ and Ar₂ are independently selected from the group consisting of

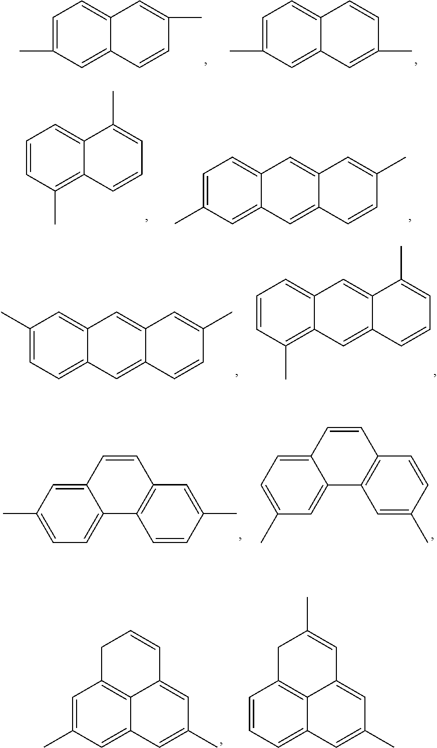

and mixtures thereof.

In some embodiments, Ar₁ and Ar₂ are independently selected from the group consisting of

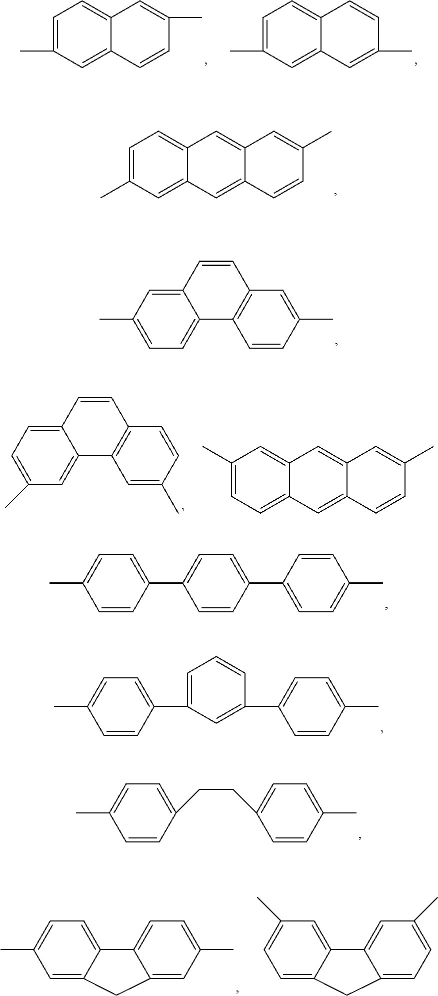

and mixtures thereof.

In some embodiments, X₁ is

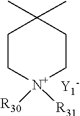

wherein R₃₀ and R₃₁ are each independently —H, —CH₃, —CH₂CH₃, —CH(CH₃)₂, —C(CH₃)₃, —CH₂—C₆H₅, or —CH₂—CH(CH₃)₂

wherein Y₁⁻ is HCO₃⁻, OH⁻, I⁻, CF₃SO₃, or

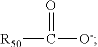

and

wherein R₅₀ is —CH₃, —CF₃, CH₃CH₂—, or CH₃CH₂CH₂—.

In some embodiments, X₂ is

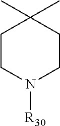

wherein R₃₀ is —H, —CH₃, —CH₂CH₃, —CH(CH₃)₂, —C(CH₃)₃, —CH₂—C₆H₅, or —CH₂—CH(CH₃)₂.

In some embodiments, X₂ is a mixture of

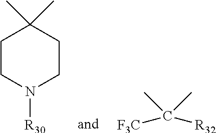

wherein R₃₀ is —H, —CH₃, —CH₂CH₃, —CH(CH₃)₂, —C(CH₃)₃, —CH₂—C₆H₅, or —CH₂—CH(CH₃)₂; and wherein R₃₂ is —C₆H₅.

The anion exchange polymer comprising a plurality of repeating units of formula (I) may be synthesized by two steps: 1) a superacid catalyzed polyhydroxyalkylation reaction of monomers Ar₁′ and Ar₂′ with X₁′, such as p-terphenyl as Ar₁′ and phenanthrene as Ar₂′ with N-methyl-₄-piperidone as X₁′, to form a neutral precursor polymer; and 2) a Menshutkin reaction to convert the neutral precursor polymer comprising piperidine-based groups to the anion exchange polymer comprising a plurality of repeating units of formula (I) with both piperidinium-based cation groups and piperidine-based groups. Optionally, the anion exchange polymer comprising a plurality of repeating units of formula (I) with piperidine-based groups, piperidinium-based cation groups and negatively charged halide ions is converted to an anion exchange polymer comprising a plurality of repeating units of formula (I) with piperidine-based groups, piperidinium-based cation groups and negatively charged bicarbonate ions by soaking the polymer in sodium bicarbonate or potassium bicarbonate solution before the polymer is made into a membrane.

The polyhydroxyalkylation reaction of monomers Ar₁′ and Ar₂′ with monomer X₁′ followed by the Menshutkin reaction provides an anion exchange polymer with a polymer backbone free of ether bonds, which results in high chemical stability of the polymer. The incorporation of electron-rich monomers Ar₁′ and Ar₂′ into the anion exchange polymer provides a hydrophobic polymer backbone, and the incorporation of monomer X₁′ into the anion exchange polymer provides the polymer with piperidinium or piperidinium salt-based anion exchange property that helps to achieve stable high OH⁻ conductivity, as well as piperidine-based functional group that is important to reduce the polymer swelling and reduce the gas crossover. The combination of the hydrophobic polymer backbone, the piperidine-based functional group, and alkaline stable piperidinium or piperidinium salt-based cation functional groups provides the novel anion exchange polymer with high OH⁻ conductivity, high chemical stability, high mechanical strength, low swelling in alkaline conditions, low gas crossover, and long-term performance stability. The molar ratio of Ar₁′ monomer to Ar₂′ monomer can be in a range of 20:1 to 1:20, or in a range of 10:1 to 1:10, or in a range of 5:1 to 1:5. The molar ratio of X1′ monomer to Ar₁′ and Ar₂′ monomers can be in a range of 1.2:1 to 1:1.2, or in a range of 1.1:1 to 1:1.1, or in a range of 1.05:1 to 1:1.05.

The superacid catalyzed polyhydroxyalkylation reaction can be carried out at 0° C. to 50° C., or at 10° C. to 30° C., or at 20° C. to 30° C. for 2 h to 72 h, or 10 h to 48 h, or 12 to 24 h. Suitable superacid catalysts include, but are not limited to, trifluoromethanesulfonic acid (CF₃SO₃H (TFSA)), methanesulfonic acid (MSA), fluorosulfuric acid (FSO₃H), or mixtures thereof. Solvents for the polyhydroxyalkylation reaction are those that can dissolve one or more of the monomers. Suitable solvents include, but are not limited to, methylene chloride, chloroform, trifluoroacetic acid (TFA), or mixtures thereof.

The Menshutkin reaction is used to react the neutral precursor polymer comprising piperidine-based groups with an alkyl halide to convert about 50 mol % to 99 mol % of the neutral piperidine-based groups to piperidinium-based cation groups to form the anion exchange polymer comprising a plurality of repeating units of formula (I) with both piperidinium-based cation groups and piperidine-based groups. Suitable alkyl halides include, but are not limited to, alkyl iodides or alkyl bromides. The Menshutkin reaction can be carried out at 10° C. to 80° C., or at 20° C. to 30° C. for 2 h to 72 h, or 10 h to 48 h, or 12 to 24 h. Solvents for the Menshutkin reaction are those that can dissolve the neutral precursor polymer comprising piperidine-based groups. Suitable solvents include, but are not limited to, N-methylpyrrolidone (NMP), N, N-dimethyl acetamide (DMAC), N, N-dimethylformamide (DMF), dimethyl sulfoxide (DMSO), 1,3-dioxolane, or mixtures thereof. To synthesize the anion exchange polymer comprising a plurality of repeating units of formula (I) with both piperidinium-based cation groups and piperidine-based groups, the molar ratio of the alkyl halide to the piperidine-based groups of the neutral precursor polymer should be controlled in a range of 0.5/1 to 1:1 for the Menshutkin reaction.

The anion exchange polymer comprising a plurality of repeating units of formula (I) has a weight average molecular weight in a range of 10,000 to 50,000,000 Daltons, or in a range of 50,000 to 40,000,000 Daltons.

The anion exchange membrane can be used in fuel cells, electrolyzers, flow batteries, electrodialyzers, waste metal recovery systems, electrocatalytic hydrogen production systems, desalinators, water purifiers, waste water treatment systems, ion exchangers, or CO₂ separators.

In some embodiments, the anion exchange membrane comprises a nonporous symmetric dense film membrane, an integrally-skinned asymmetric membrane, a reinforced composite membrane, or a thin film composite membrane. By “dense” we mean that the membrane does not have pores larger than 1 nm.

In some embodiments, the integrally-skinned asymmetric membrane, the reinforced composite membrane, or the thin film composite membrane comprises a porous substrate material impregnated or coated with the anion exchange polymer. The porous substrate membrane may be prepared from a polymer different from the anion exchange polymer.

In some embodiments, the nonporous symmetric dense film membrane, the integrally-skinned asymmetric membrane, the reinforced composite membrane, or the thin film composite membrane may be a flat sheet membrane.

In some embodiments, the nonporous symmetric dense film anion exchange membrane is prepared using a method comprising: 1) preparing a composite anion exchange membrane casting solution by dissolving the anion exchange polymer comprising a plurality of repeating units of formula (I) in a solvent or a solvent mixture, dispersing a H₂ recombination catalyst and optionally a radical scavenger in a solvent or a solvent mixture, and mixing the anion exchange polymer solution with the dispersed H₂ recombination catalyst suspension to form the composite anion exchange membrane casting solution; 2) casting the composite anion exchange membrane casting solution on a nonporous substrate to form a uniform layer of the composite anion exchange membrane casting solution; 3) drying the composite anion exchange membrane casting solution layer to form a dried membrane on the nonporous substrate at 50° C. to 180° C., or at 50° C. to 120° C., or at 80° C. to 120° C.; and optionally 4) ion exchanging the halide anions of the anion exchange polymer in the membrane with hydroxide, bicarbonate, carbonate ions, or a combination thereof if the anion exchange polymer has halide anions before membrane fabrication to form the nonporous symmetric dense film composite anion exchange membrane. The nonporous substrate is removed from the membrane when the membrane is used in a desired application. The solvent used to dissolve the anion exchange polymer can be selected from, but is not limited to, NMP, DMAc, DMF, DMSO, 1,3-dioxolane, acetic acid, trifluoroacetic acid (TFA), trifluoromethanesulfonic acid (TFSA), or mixtures thereof. The nonporous substrate used for the fabrication of the nonporous symmetric dense film membrane can be selected from, but is not limited to, glass plate, polymer films made from polymers that are insoluble in the solvent used to dissolve the anion exchange polymer, such as polyester such as polyethylene terephthalate (PET), polyimide, poly (ether ether ketone) (PEEK), polyphenylene sulfide (PPS), polytetrafluoroethylene (PTFE), perfluoroalkoxy polymer, fluorinated ethylene propylene, polyolefins such as polyethylene (PE), polypropylene (PP), and copolymers of PE and PP, copolymers of tetrafluoroethylene and ethylene, copolymers of tetrafluoroethylene and propylene, polychlorotrifluoroethylene (PCTFE), copolymers of chlorotrifluoroethylene and vinylidene fluoride, copolymers of chlorotrifluoroethylene and ethylene, or combinations thereof.

In some embodiments, the integrally-skinned asymmetric anion exchange membrane is prepared using a method comprising: 1) making a composite anion exchange membrane casting solution comprising the anion exchange polymer with formula (I), solvents which are miscible with water and can dissolve the anion exchange polymer, and non-solvents which cannot dissolve the anion exchange polymer, a H₂ recombination catalyst, and optionally a radical scavenger; 2) casting a layer of the composite anion exchange membrane casting solution onto a supporting substrate; 3) evaporating the solvent and non-solvent from the surface of the coated layer and then coagulating the coated layer in a coagulating bath to form the integrally-skinned asymmetric membrane structure; 4) drying the membrane at 50° C. to 150° C., or at 50° C. to 120° C., or at 80° C. to 120° C.; and optionally 5) ion exchanging the halide anions of the anion exchange polymer in the membrane with hydroxide, bicarbonate, carbonate ions, or a combination thereof if the anion exchange polymer has halide anions before membrane fabrication to form the integrally-skinned asymmetric anion exchange membrane. In some embodiments, the supporting substrate is removed from the membrane when the membrane is used in a desired application. In some embodiments, the supporting substrate is part of the final integrally-skinned asymmetric anion exchange membrane. The supporting substrate may comprise polymer films made from polymers that are insoluble in the solvent used to dissolve the anion exchange polymer, such as polyester such as polyethylene terephthalate (PET), polyimide, poly (ether ether ketone) (PEEK), polyphenylene sulfide (PPS), polytetrafluoroethylene (PTFE), perfluoroalkoxy polymer, fluorinated ethylene propylene, polyolefins such as polyethylene (PE), polypropylene (PP), and copolymers of PE and PP, copolymers of tetrafluoroethylene and ethylene, copolymers of tetrafluoroethylene and propylene, polychlorotrifluoroethylene (PCTFE), copolymers of chlorotrifluoroethylene and vinylidene fluoride, copolymers of chlorotrifluoroethylene and ethylene, or combinations thereof. The solvents for the preparation of the integrally-skinned asymmetric membrane include, but are not limited to, NMP, DMAc, DMF, DMSO, dioxanes, 1,3-dioxolane, acetic acid, trifluoroacetic acid (TFA), trifluoromethanesulfonic acid (TFSA), and mixtures thereof. The non-solvents for the preparation of the integrally-skinned asymmetric membrane include, but are not limited to, acetone, methanol, ethanol, tetrahydrofuran (THF), toluene, n-octane, n-decane, lactic acid, citric acid, isopropanol, and mixtures thereof. The integrally-skinned asymmetric membrane may have a thin nonporous dense layer less than 500 nm on a microporous support layer.

In some embodiments, the reinforced composite anion exchange membrane is prepared using a method comprising: 1) making a composite anion exchange membrane solution comprising the anion exchange polymer with formula (I), solvents which are miscible with water and can dissolve the anion exchange polymer, and non-solvents which cannot dissolve the anion exchange polymer, a H₂ recombination catalyst, and optionally a radical scavenger; 2) impregnating a porous matrix support membrane with the composite anion exchange membrane to fill the pores with the solution via dip-coating, soaking, spraying, painting, or other known conventional solution impregnating method; 3) drying the impregnated membrane at 50° C. to 150° C., or at 50° C. to 120° C., or at 80° C. to 120° C.; and optionally 4) ion exchanging the halide anions of the anion exchange polymer in the pores of the reinforced membrane with hydroxide, bicarbonate, carbonate ions, or a combination thereof if the anion exchange polymer has halide anions before membrane fabrication to form the reinforced composite anion exchange membrane with interconnected anion exchange polymer domains in a porous matrix. The solvents for the preparation of the thin film composite anion exchange membrane include, but are not limited to, NMP, DMAc, DMF, DMSO, dioxanes, 1,3-dioxolane, acetic acid, trifluoroacetic acid (TFA), trifluoromethanesulfonic acid (TFSA), and mixtures thereof. The porous matrix should have good thermal stability (stable up to at least 120° C.), high stability under high pH condition (e.g., pH greater than 8), high resistance to oxidizing and reducing conditions (insoluble and no performance drop under oxidizing and reducing conditions), high mechanical strength (no dimensional change under the system operation conditions), as well as other factors dictated by the operating conditions for electrochemical reactions. The porous matrix must be compatible with the electrochemical cell chemistry and meet the mechanical demands of cell stacking or winding assembly operations.

The polymers suitable for the preparation of the porous matrix can be selected from, but not limited to, polyolefins such as polyethylene and polypropylene, polyamide such as Nylon 6 and Nylon 6,6, polyester, cellulose acetate, polybenzimidazole, fluorocarbon-based polymer such as PTFE, PCTFE, and PVDF, polycarbonate, cellulose, or combinations thereof. These polymers provide a range of properties such as low cost, high stability in alkaline water, good mechanical stability, and ease of processability for porous matrix fabrication.

The porous matrix can either a non-woven matrix or a woven matrix and have either a symmetric porous structure or an asymmetric porous structure. The porous matrix can be formed by an electrospinning process, a phase inversion membrane fabrication approach followed by direct air drying, or by phase inversion followed by solvent exchange methods. The porous matrix also can be fabricated via a dry processing of thermoplastic polyolefins or a wet processing of thermoplastic olefins. The dry processing of thermoplastic polyolefins utilizes extrusion to bring the polymer above its melting point and form it into the desired shape. Subsequent annealing and stretching processes may also be done to increase the crystallinity and orientation and dimension of the pores. The wet processing of polyolefin porous matrix is done with the aid of a hydrocarbon liquid or low molecular weight oil mixed with the polymer resin or a mixture of the polymer resin and inorganic nanoparticles in the melt phase. The melt mixture is extruded through a die similar to the dry processed separators.

The thickness of the porous matrix can be in a range of 10-400 micrometers, or a range of 10-200 micrometers, or a range of 10-100 micrometers, or a range of 20-100 micrometers. The pore size of the porous matrix can be in a range of 1 micrometer to 500 micrometers, or a range of 10 micrometer to 200 micrometers, or a range of 50 micrometers to 100 micrometer.

Another aspect of the invention is a membrane electrode assembly. In one embodiment, the membrane electrode assembly comprises: an anion exchange membrane comprising: an anion exchange polymer; and a hydrogen recombination catalyst dispersed in the anion exchange polymer; a cathode comprising a cathode catalyst on a first surface of the anion exchange membrane; and optionally an anode comprising an anode catalyst on a second surface of the anion exchange membrane; wherein the anion exchange polymer comprises a plurality of repeating units of formula (I)

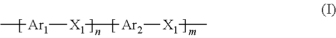

wherein Ar₁ and Ar₂ are independently selected from the group consisting of:

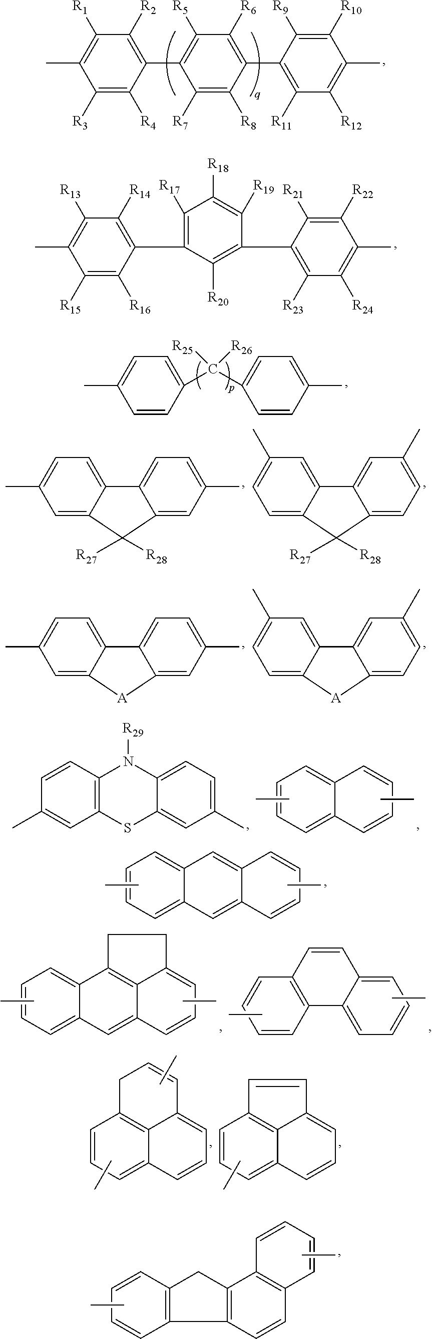

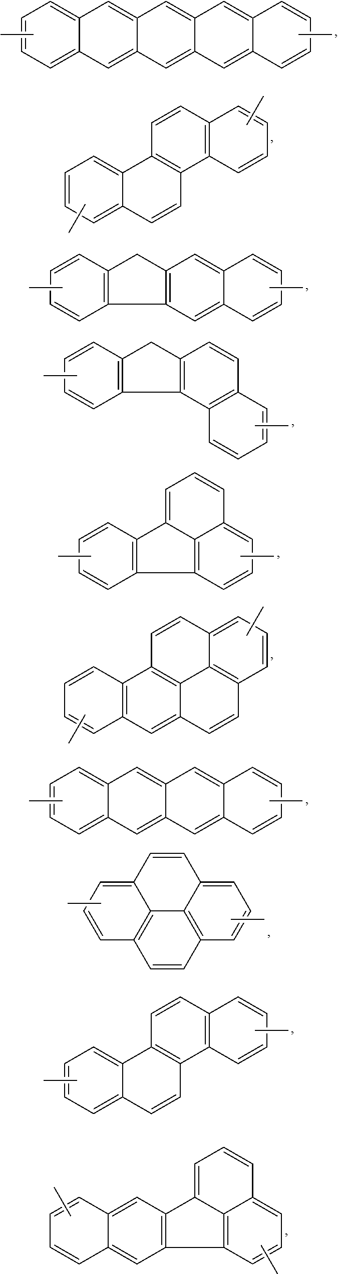

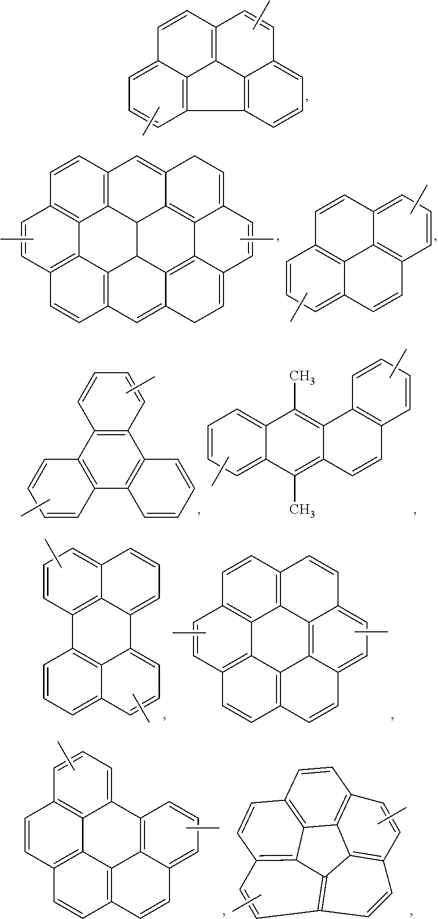

and mixtures thereof;

wherein X₁ is selected from the group consisting of:

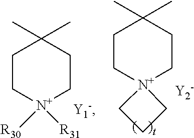

and mixtures thereof;

wherein X₂ is selected from the group consisting of:

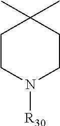

or a mixture of

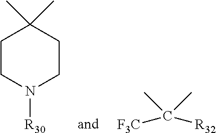

wherein Ar₁ and Ar₂ are the same or different from each other;

wherein Y₁⁻ and Y₂⁻ are anions;

wherein R₁-R₂₈ are each independently hydrogen, a halide, an alkyl group, an alkenyl group, an alkynyl group, or an aryl group, and the alkyl, alkenyl, alkynyl, or aryl groups are optionally substituted with a halide or a positively charged functional group;

wherein R₂₉-R₃₁ are each independently hydrogen, an alkyl group, an alkenyl group, an alkynyl group, or an aryl group, and the alkyl, alkenyl, alkynyl or aryl groups are optionally substituted with a halide or a positively charged functional group;

wherein R₃₂ is an alkyl group, an alkenyl group, an alkynyl group, or an aryl group, and the alkyl, alkenyl, alkynyl or aryl group is optionally substituted with a halide or a positively charged functional group;

wherein A is O, S, or NR₁₀₀;

wherein R₁₀₀ is hydrogen, an alkyl group, an alkenyl group, an alkynyl group, or an aryl group, and the alkyl, alkenyl, alkynyl, or aryl groups are optionally substituted with a halide or a positively charged functional group;

wherein n is an integer from 10 to 100,000;

wherein m is an integer from 5 to 50,000 and the molar ratio of n/m is in a range of 1:1 to 99:1;

wherein p is 1, 2, 3, or 4;

wherein q is 0, 1, 2, or 3; and

wherein tis 1, 2, 3, 4, 5, or 6.

In some embodiments, the hydrogen recombination catalyst comprises Pt, Pt supported on carbon, silica, titania, or zirconia, PtCo, PtCo supported on carbon, silica, titania, or zirconia, Pd, Pd supported on carbon, silica, titania, or zirconia, PdCo, PdCo supported on carbon, silica, titania, or zirconia, Ru, Ru supported on carbon, silica, titania, or zirconia, RuCo, RuCo supported on carbon, silica, titania, or zirconia, or mixtures thereof.

In some embodiments, the anion exchange membrane further comprises a radical scavenger. Any suitable radical scavenger can be used. Suitable radical scavengers include, but are not limited to, CeO₂, Ce(OH)₄, NbO₂, NbO, CeO₂/ZrO₂, CeO₂/NbO₂, TiO₂, HfO₂, Bi₂O₃, BeO, Ta₂O₅, Ce(OH)₄/ZrO₂, CeO₂—TiC, MnO, MnO₂, MnO₂/SiO₂—SO₃H, boehmite, silica-supported Cr, Co or Mn, or mixtures thereof.

In some embodiments, the membrane electrode assembly further comprises: a cathode porous transport layer adjacent to the cathode; and an anode porous transport layer or an anode catalyst-coated anode porous transport layer adjacent to the second surface of the anion exchange membrane.

In some embodiments, Ar₁ and Ar₂ are independently selected from the group consisting of

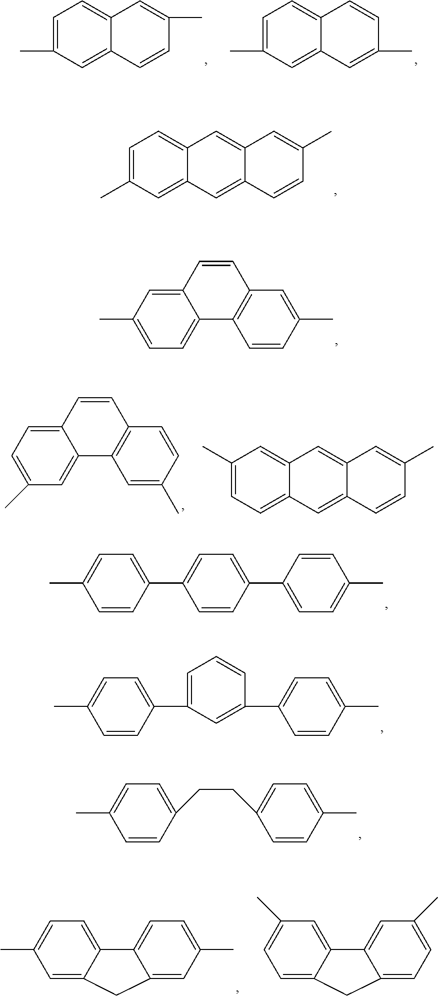

and mixtures thereof.

In some embodiments, X₁ is

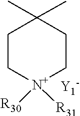

wherein R₃₀ and R₃₁ are each independently —H, —CH₃, —CH₂CH₃, —CH(CH₃)₂, —C(CH₃)₃, —CH₂—C₆H₅, or —CH₂—CH(CH₃)₂;

wherein Y₁⁻ is HCO₃⁻, OH⁻, I⁻, CF₃SO₃⁻, or

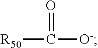

and

wherein R₅₀ is —CH₃, —CF₃, CH₃CH₂—, or CH₃CH₂CH₂—;

and wherein X₂ is

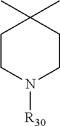

wherein R₃₀ is —H, —CH₃, —CH₂CH₃, —CH(CH₃)₂, —C(CH₃)₃, —CH₂—C₆H₅, or —CH₂—CH(CH₃)₂.

In some embodiments, the anode and the cathode catalysts are platinum group metal (PGM) electrocatalysts or PGM-free electrocatalysts. The anode and the cathode catalysts are for oxygen evolution reaction and hydrogen evolution reaction, respectively. The term “platinum group metal” (PGM) means the six noble, precious metallic elements including ruthenium (Ru), rhodium (Rh), palladium (Pd), osmium (Os), iridium (Ir), and platinum (Pt).

In some embodiments, unsupported or supported iridium (Ir) based PGM electrocatalysts are used for the oxygen evolution reaction (OER) on the anode and platinum (Pt) or carbon supported platinum electrocatalyst (Pt/C) is used for the hydrogen evolution reaction (HER) on the cathode for AEM water electrolysis. Both Ir and Pt based PGM catalysts are very expensive and scarce. The anode and the cathode catalysts should have good electrical conductivity, and good electrocatalytic activity and stability. In some embodiments, PGM-free electrocatalysts are used for OER and/or HER for AEM water electrolysis. Suitable cathode catalysts can be selected from, but are not limited to, Ni-based alloys such as Ni—Mo, Ni—Al, Ni—Cr, Ni—Sn, Ni—Co, Ni—W, and Ni—Al—Mo, metal carbides such as Mo₂C, metal phosphides such as CoP, metal dichalcogenides such as MoSe₂, and mixtures thereof. Suitable anode catalysts can be selected from, but are not limited to, Ni—Fe alloy, Ni-Mo alloy, spinel CuₓCo₃ₓO₃, Ni—Fe—W—B layered double hydroxide, Ni—Fe—Ce—B layered double hydroxide, Ni—Fe—Co—B layered double hydroxide, Ni—Fe layered double hydroxide nanoplates on carbon nanotubes, immobilized metal catalyst on conductive supports, and mixtures thereof.

In some embodiments, the anode comprising an anode catalyst on a first surface of the anion exchange membrane is formed by coating an anode catalyst ink on the first surface of the anion exchange membrane via meniscus coating, knife coating, spray coating, slot die coating, Mayer rod coating, gravure coating, comma coating, painting, inkjet printing, curtain printing, or other known conventional ink coating technologies, followed by drying the coated anion exchange membrane.

In some embodiments, the cathode comprising a cathode catalyst on a second surface of the anion exchange membrane is formed by coating a cathode catalyst ink on the second surface of the anion exchange membrane via meniscus coating, knife coating, spray coating, slot die coating, Mayer rod coating, gravure coating, comma coating, painting, inkjet printing, curtain printing, or other known conventional ink coating technologies, followed by drying the coated anion exchange membrane.

In some embodiments, the anode catalyst ink comprises the anode catalyst, an OH⁻ exchange ionomer as a binder, and a solvent. In some embodiments, the cathode catalyst ink comprises the cathode catalyst, an OH⁻ exchange ionomer as a binder, and a solvent. The OH exchange ionomer binder creates OH⁻ transport pathways between the membrane and the reaction sites within the electrodes and thus drastically improves the utilization of the electrocatalyst particles while reducing the internal resistance. The OH⁻ exchange ionomer binder can have a chemical structure similar to the anion exchange polymer described above, so that the binder will allow low interfacial resistance and similar expansion in contact with water to avoid catalyst delamination, but OH⁻ conductivity and high oxygen and hydrogen permeance. The solvent can be selected from, but is not limited to, water, alcohol, or a mixture thereof.

The anode gas diffusion layer and the cathode gas diffusion layer simultaneously transport electrons, heat, and products with minimum voltage, current, thermal, interfacial, and fluidic losses. The cathode gas diffusion layer can be made from, but is not limited to, stainless steel, titanium meshes, titanium felts, titanium foams, or carbon-based materials such as non-woven carbon paper, non-woven carbon cloth, or woven carbon cloth. The anode gas diffusion layer can be made from, but is not limited to, stainless steel, titanium meshes, titanium felts, or titanium foams.

### EXAMPLES

The following examples are provided to illustrate one or more preferred embodiments of the invention but are not limited embodiments thereof. Numerous variations can be made to the following examples that lie within the scope of the invention.

### Example 1

Preparation of composite anion exchange membrane (abbreviated as PTPPB-PTPP/Pt/CeO₂ composite AEM) comprising poly (p-terphenyl-phenanthrene-N,N-dimethyl-4-piperidinium bicarbonate)-co-poly (p-terphenyl-phenanthrene-N-methyl-4-piperidine) anion exchange polymer (abbreviated as PTPPB-PTPP), Pt black H₂ recombination catalyst, and CeO₂ radical scavenger

Terphenyl (103.6 g, 450 mmol), phenanthrene (8.9 g, 50 mmol) and 1-methyl-4-piperidone (62.2 g, 550 mmol) were mixed with 400 mL of dichloromethane and cooled in icy water to 0° C. To the stirred mixture, trifluoroacetic acid (60 mL) and trifluoromethanesulfonic acid (400 mL) were added dropwise consecutively under stirring. The mixture was stirred for 11 hours while kept at 0° C. The reaction mixture was blended with water to generate a slurry. The slurry was filtered and rinsed with water, after which the filter cake was soaked in water containing sodium hydroxide overnight. The mixture was again filtered, and the filter cake was washed with water until pH neutral. The obtained solid poly (p-terphenyl-phenanthrene-N-methyl-4-piperidine) (abbreviated as PTPP) precursor polymer was then dried at 60° C. overnight, followed by drying under vacuum at 80° C. overnight.

The obtained PTPP polymer (about 500 mmol of N-methyl-4-piperidine units) was dissolved in 1.6 L of dimethyl sulfoxide containing 40 mL of trifluoroacetic acid. To the solution, iodomethane (750 mmol) and anhydrous potassium carbonate were added. While protected from light, the mixture was stirred for 24 hours. The reaction mixture was poured in KHCO₃ aqueous solution. The obtained mixture was filtered, and the filter cake was washed with KHCO₃ aqueous solution and water several times until pH neutral. The obtained solid was dried at 60° C. for at least 24 h to obtain dried poly (p-terphenyl-phenanthrene-N,N-dimethyl-4-piperidinium bicarbonate)-co-poly (p-terphenyl-phenanthrene-N-methyl-4-piperidine) (abbreviated as PTPPB-PTPP) anion exchange polymer. ¹H NMR analysis result for the

PTPPB-PTPP polymer confirmed that the polymer had 83 mol % of N,N-dimethyl-4-piperidinium bicarbonate functional groups converted from the N-methyl-4-piperidine functional groups on the PTPP precursor polymer and had 17 mol % of unconverted N-methyl-4-piperidine functional groups.

12.5 g PTPPB-PTPP polymer was dissolved in 50 g of dimethyl sulfoxide (DMSO) and 5.0 g of trifluoroacetic acid (TFA) by stirring for about 5-6 h at 60° C. to form a PTPPB-PTPP polymer solution. 0.50 g of Pt black, 0.089 g of CeO₂ nanoparticles, and 75.0 g of DMSO solvent were mixed together in a glass jar using a sonic bath for about 5 min to form a Pt/CeO₂ suspension. Then PTPPB-PTPP polymer solution prepared above was added to the Pt/CeO₂ suspension and the mixture of PTPPB-PTPP/Pt/CeO₂ was further mixed using a high shear mixer and a sonication probe. 48.0 g of additional PTPPB-PTPP polymer, 30.0 g of ethanol and 10.0 g of TFA were added to the mixture of PTPPB-PTPP/Pt/CeO₂ and stirred for 1-2 h at 60° C., and then 12 h at RT to form the PTPPB-PTPP/Pt/CeO₂ composite anion exchange membrane casting solution. The casting solution was filtered through a 400 μm filter kept overnight to degas.

The degassed PTPPB-PTPP/Pt/CeO2 composite anion exchange membrane casting solution was cast onto a nonporous polyester substrate using a casting knife and dried at 80° C. to form PTPPB-PTPP/Pt/CeO₂ composite anion exchange membrane (abbreviated as PTPPB-PTPP/Pt/CeO₂ composite AEM).

### Example 2

Preparation of 2-layer catalyst coated membrane (CCM) comprising 40% Pt/C cathode catalyst coating layer on one surface of the PTPPB-PTPP/Pt/CeO₂ composite AEM (abbreviated as Pt-C/PTPPB-PTPP/Pt/CeO₂ CCM)

A 2-layer CCM comprising 40% Pt/C cathode catalyst coating layer on one surface of the PTPPB-PTPP/Pt/CeO₂ composite AEM was prepared by a direct wet coating method using a Mayer rod to coat a 40% Pt/C cathode hydrogen evolution reaction (HER) catalyst ink directly on one surface of the PTPPB-PTPP/Pt/CeO₂ composite AEM. A 40% Pt/C cathode catalyst ink was prepared by mixing the 40% Pt/C catalyst and PTPPB-PTPP anion exchange polymer as an ionomer in ultra-pure water and alcohol such as ethanol. The mixture was finely dispersed using a combination of mixing and ultrasonicating. The Pt/C ink was coated onto one surface of the PTPPB-PTPP/Pt/CeO₂ composite AEM using the Mayer rod for only about 5-10 min and then dried at 60-100° C. to form the 2-layer CCM comprising 40% Pt/C cathode catalyst coating layer on one surface of the PTPPB-PTPP/Pt/CeO₂ composite AEM.

### Comparative Example 1

Preparation of anion exchange membrane (abbreviated as PTPPB-PTPP AEM) comprising poly (p-terphenyl-phenanthrene-N,N-dimethyl-4-piperidinium bicarbonate)-co-poly (p-terphenyl-phenanthrene-N-methyl-4-piperidine) anion exchange polymer (abbreviated as PTPPB-PTPP)

12.5 g PTPPB-PTPP polymer was dissolved in 50 g of dimethyl sulfoxide (DMSO) and 5.0 g of trifluoroacetic acid (TFA) by stirring for about 5-6 h at 60° C. to form a PTPPB-PTPP polymer casting solution. The casting solution was filtered through a 400 μm filter kept overnight to degas.

The degassed PTPPB-PTPP anion exchange membrane casting solution was cast onto a nonporous polyester substrate using a casting knife and dried at 80° C. to form PTPPB-PTPP anion exchange membrane (abbreviated as PTPPB-PTPP AEM).

### Comparative Example 2

Preparation of 2-layer catalyst coated membrane (CCM) comprising 40% Pt/C cathode catalyst coating layer on one surface of the PTPPB-PTPP AEM (abbreviated as Pt-C/PTPPB-PTPP CCM)

A 2-layer CCM comprising 40% Pt/C cathode catalyst coating layer on one surface of the PTPPB-PTPP AEM prepared in Comparative Example 1 was prepared by a direct wet coating method using a Mayer rod to coat a 40% Pt/C cathode hydrogen evolution reaction (HER) catalyst ink directly on one surface of the PTPPB-PTPP AEM. A 40% Pt/C cathode catalyst ink was prepared by mixing the 40% Pt/C catalyst and PTPPB-PTPP anion exchange polymer as an ionomer in ultra-pure water and alcohol such as ethanol. The mixture was finely dispersed using a combination of mixing and ultrasonicating. The Pt/C ink was coated onto one surface of the PTPPB-PTPP AEM using the Mayer rod for only about 5-10 min and then dried at 60-100° C. to form the 2-layer CCM comprising 40% Pt/C cathode catalyst coating layer on one surface of the PTPPB-PTPP AEM.

### Example 3

Water electrolysis performance and H₂ crossover study on Pt-C/PTPPB-PTPP/Pt/CeO₂ CCM and PTPPB-PTPP CCM

The water electrolysis performance and H₂ crossover of the 2-layer Pt-C/PTPPB-PTPP/Pt/CeO₂ CCM comprising 40% Pt/C cathode catalyst coating layer on one surface of the PTPPB-PTPP/Pt/CeO₂ composite AEM prepared in Example 2 and the 2-layer Pt-C/PTPPB-PTPP CCM comprising 40% Pt/C cathode catalyst coating layer on one surface of the PTPPB-PTPP AEM prepared in Comparative Example 2 were evaluated using a single water electrolysis cell at atmospheric pressure in a Scribner unit. The 2-layer Pt-C/PTPPB-PTPP/Pt/CeO₂ CCM and the 2-layer Pt-C/PTPPB-PTPP CCM were sandwiched between a carbon paper (cathode PTL) and a 2-layer NiFeCeBOₓ anode O₂ evolution catalyst-coated porous transport layer (PTL), respectively, to form membrane electrode assemblies (MEAs) inside the testing cell.

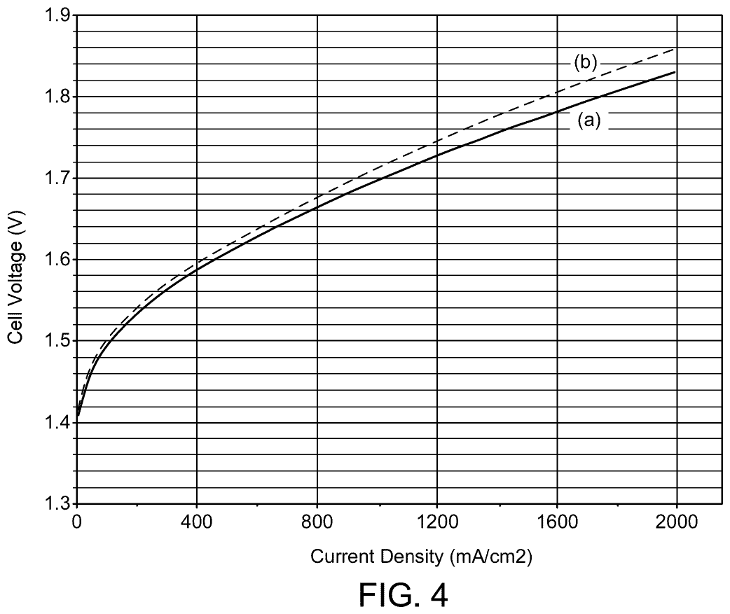

A water electrolysis test station (Scribner 600 electrolyzer test system), modified for testing with potassium hydroxide feed, was used to evaluate the water electrolysis performance of the membrane electrode assemblies (MEAs) comprising the 2-layer Pt-C/PTPPB-PTPP/Pt/CeO₂ CCM or 2-layer Pt-C/PTPPB-PTPP CCM in a single electrolyzer cell with an active membrane area of 5 cm². The test station included an integrated power supply, a potentiostat, an impedance analyzer for electrochemical impedance spectroscopy (EIS) and high-frequency resistance (HFR), and real-time sensors for product flow rate and cross-over monitoring. The testing was conducted at 55° C. under 15 psig pressure with a 1 wt % KOH feed supplied to the anode side of the test cell. The polarization curves as shown in FIG. 4 for the MEAs comprising the 2-layer Pt-C/PTPPB-PTPP/Pt/CeO₂ CCM or 2-layer Pt-C/PTPPB-PTPP CCM at 55° C. showed that the MEA comprising 2-layer Pt-C/PTPPB-PTPP/Pt/CeO₂ CCM had slightly lower cell voltage than the MEA comprising 2-layer Pt-C/PTPPB-PTPP CCM at >0.4 A/cm² current densities. In addition, the H₂ crossover from the cathode side to the anode side of the test cell indicated by the H₂ concentration (0.17 mol % H₂ in O₂) in O₂ in the anode side of the test cell comprising the MEA with 2-layer Pt-C/PTPPB-PTPP/Pt/CeO₂ CCM was much lower than that in the anode side of the test cell comprising the MEA with 2-layer Pt-C/PTPPB-PTPP CCM comprising 40% Pt/C cathode catalyst coating layer on one surface of the PTPPB-PTPP AEM (0.89 mol % H₂ in O₂), demonstrating that the PTPPB-PTPP/Pt/CeO₂ composite AEM has lower H₂ crossover than the PTPPB-PTPP AEM. The low H₂ crossover for the new PTPPB-PTPP/Pt/CeO₂ composite AEM is important for safe electrolyzer operation and will improve the electrolyzer efficiency due to the lower loss of H₂ product.

### SPECIFIC EMBODIMENTS

While the following is described in conjunction with specific embodiments, it will be understood that this description is intended to illustrate and not limit the scope of the preceding description and the appended claims.

A first embodiment of the invention is a composition comprising an anion exchange polymer; and a hydrogen recombination catalyst dispersed in the anion exchange polymer; wherein the anion exchange polymer comprises a plurality of repeating units of formula (I)

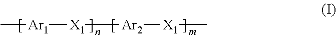

wherein Ar₁ and Ar₂ are independently selected from the group consisting of

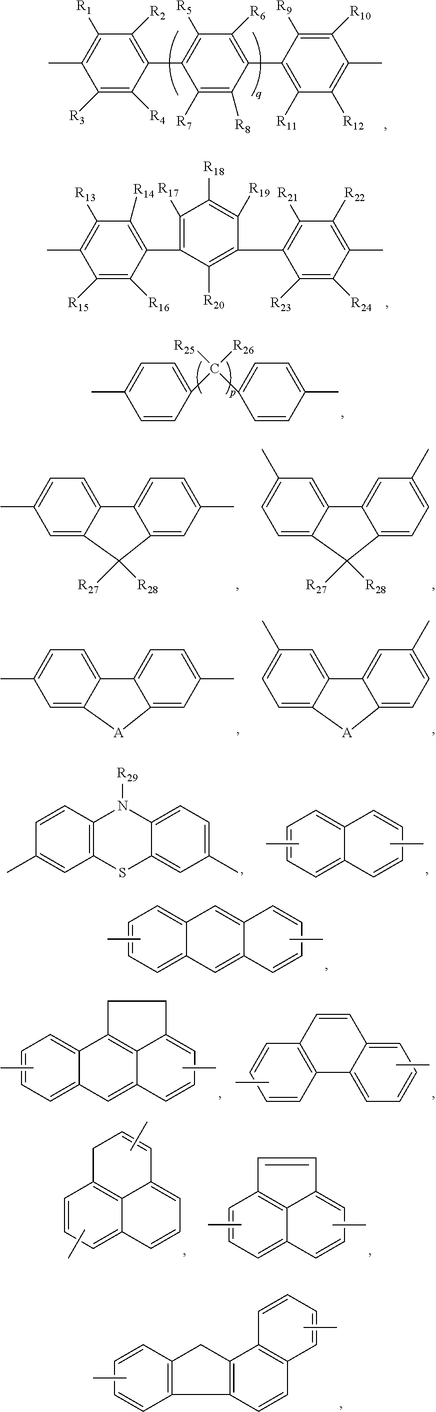

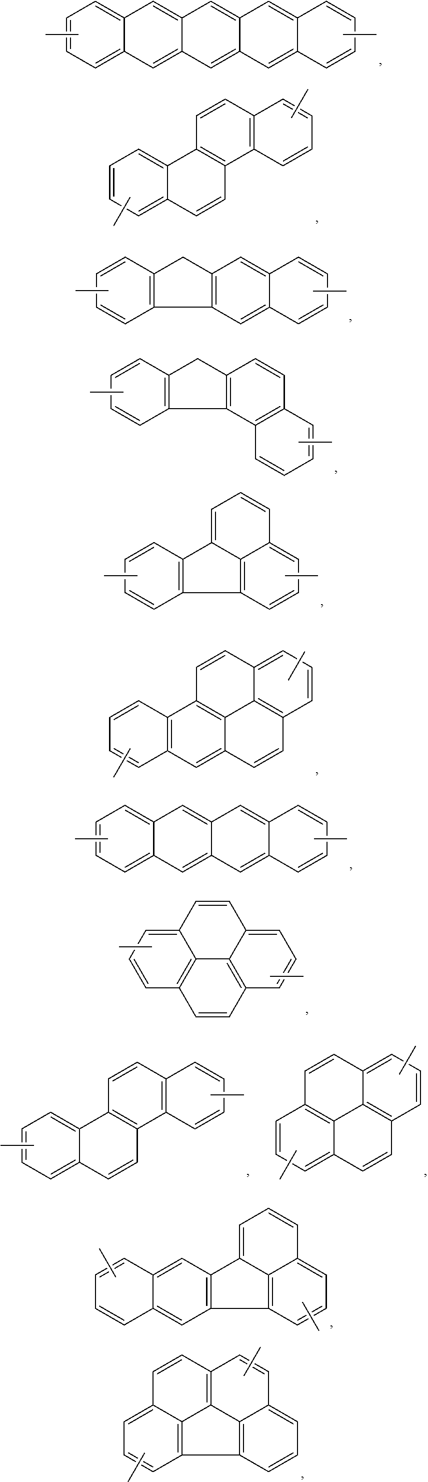

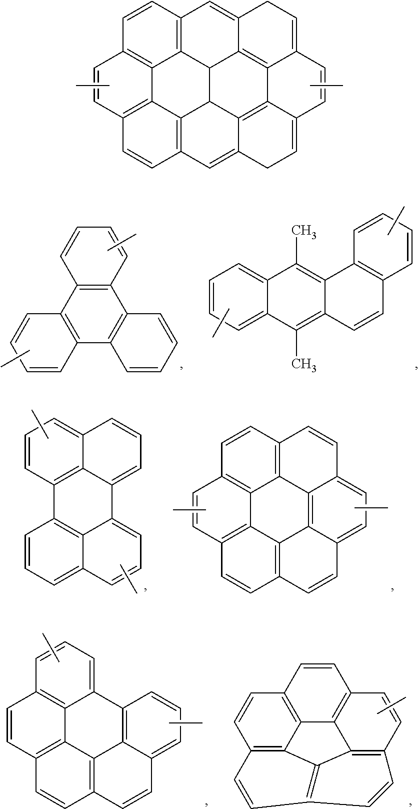

and mixtures thereof; wherein X₁ is selected from the group consisting of

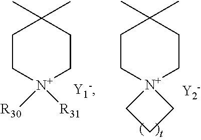

and mixtures thereof; wherein X₂ is selected from the group consisting of

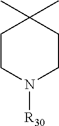

or a mixture of

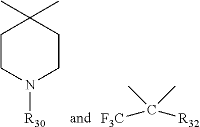

wherein Ar₁ and Ar₂ are the same or different from each other; wherein Y₁⁻ and Y₂⁻ are anions; wherein R₁-R₂₈ are each independently hydrogen, a halide, an alkyl group, an alkenyl group, an alkynyl group, or an aryl group, and the alkyl, alkenyl, alkynyl, or aryl groups are optionally substituted with a halide or a positively charged functional group; wherein R₂₉-R₃₁ are each independently hydrogen, an alkyl group, an alkenyl group, an alkynyl group, or an aryl group, and the alkyl, alkenyl, alkynyl or aryl groups are optionally substituted with a halide or a positively charged functional group; wherein R₃₂ is an alkyl group, an alkenyl group, an alkynyl group, or an aryl group, and the alkyl, alkenyl, alkynyl or aryl group is optionally substituted with a halide or a positively charged functional group; wherein A is O, S, or NR₁₀₀; wherein R₁₀₀ is hydrogen, an alkyl group, an alkenyl group, an alkynyl group, or an aryl group, and the alkyl, alkenyl, alkynyl, or aryl groups are optionally substituted with a halide or a positively charged functional group; wherein n is an integer from 10 to 100,000; wherein m is an integer from 5 to 50,000 and the molar ratio of n/m is in a range of 11 to 991; wherein p is 1, 2, 3, or 4; wherein q is 0, 1, 2, or 3; and wherein t is 1, 2, 3, 4, 5, or 6. An embodiment of the invention is one, any or all of prior embodiments in this paragraph up through the first embodiment in this paragraph wherein the hydrogen recombination catalyst comprises Pt, Pt supported on carbon, silica, titania, or zirconia, PtCo, PtCo supported on carbon, silica, titania, or zirconia, Pd, Pd supported on carbon, silica, titania, or zirconia, PdCo, PdCo supported on carbon, silica, titania, or zirconia, Ru, Ru supported on carbon, silica, titania, or zirconia, RuCo, RuCo supported on carbon, silica, titania, or zirconia, or mixtures thereof. An embodiment of the invention is one, any or all of prior embodiments in this paragraph up through the first embodiment in this paragraph further comprising a radical scavenger. An embodiment of the invention is one, any or all of prior embodiments in this paragraph up through the first embodiment in this paragraph wherein the radical scavenger comprises CeO₂, Ce(OH)₄, NbO₂, NbO, CeO₂/ZrO₂, CeO₂/NbO₂, TiO₂, HfO₂, Bi₂O₃, BeO, Ta₂O₅, Ce(OH)₄/ZrO₂, CeO₂—TiC, MnO, MnO₂, MnO₂/SiO₂—SO₃H, boehmite, silica-supported Cr, Co or Mn, or mixtures thereof. An embodiment of the invention is one, any or all of prior embodiments in this paragraph up through the first embodiment in this paragraph wherein Ar₁ and Ar₂ are independently selected from the group consisting of

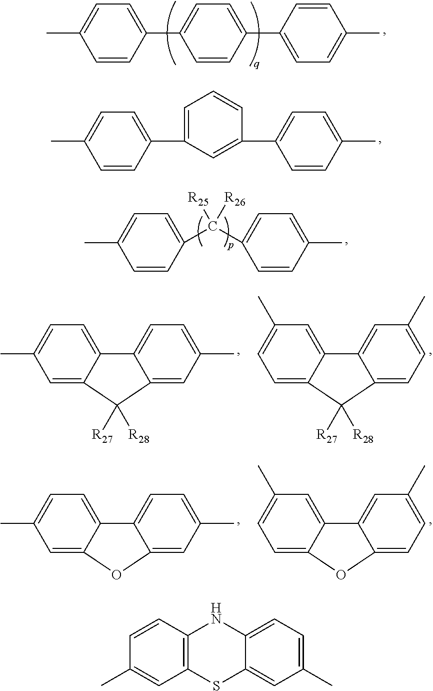

and mixtures thereof;

wherein R₂₅, R₂₆, R₂₇, and R₂₈ are each independently —H or —CH₃; wherein p is 1 or 2; and wherein q is 0 or 1. An embodiment of the invention is one, any or all of prior embodiments in this paragraph up through the first embodiment in this paragraph wherein Ar₁ and Ar₂ are independently selected from the group consisting of

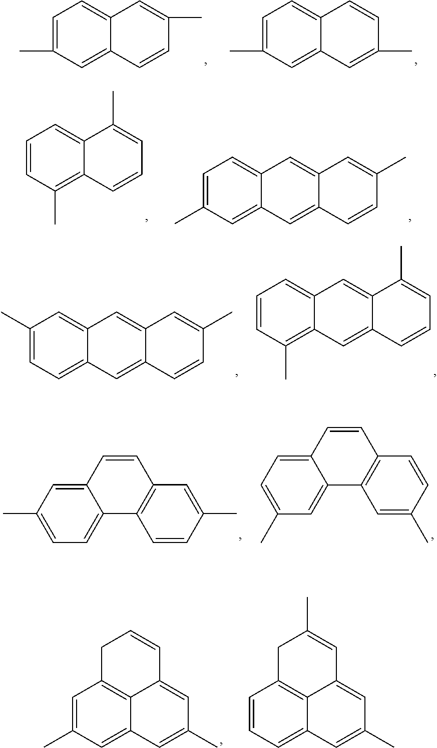

and mixtures thereof. An embodiment of the invention is one, any or all of prior embodiments in this paragraph up through the first embodiment in this paragraph wherein Ar₁ and Ar₂ are independently selected from the group consisting of

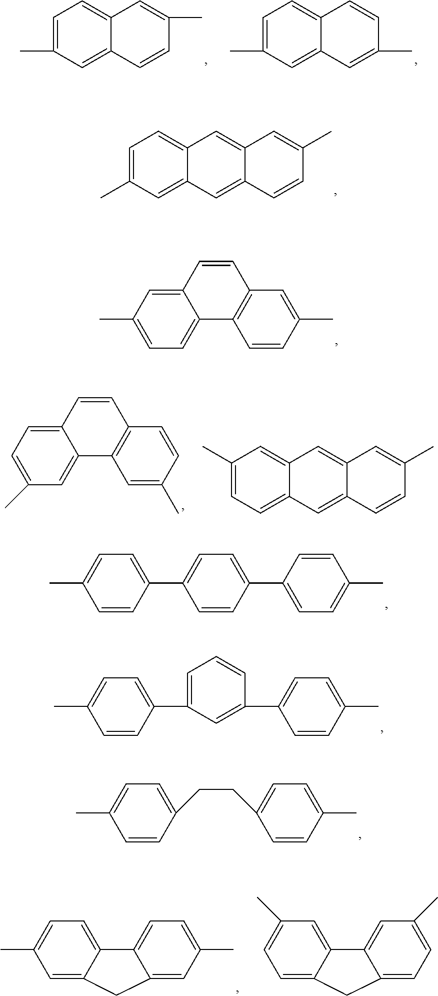

and mixtures thereof. An embodiment of the invention is one, any or all of prior embodiments in this paragraph up through the first embodiment in this paragraph wherein X₁ is

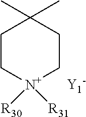

wherein R₃₀ and R₃₁ are each independently —H, —CH₃, —CH₂CH₃, —CH(CH₃)₂, —C(CH₃)₃, —CH₂—C₆H₅, or —CH₂—CH(CH₃)₂; wherein Y₁⁻ is HCO₃⁻, OH⁻, I⁻, CF₃SO₃⁻, or

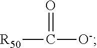

and wherein R₅₀ is —CH₃, —CF₃, CH₃CH₂—, or CH₃CH₂CH₂—. An embodiment of the invention is one, any or all of prior embodiments in this paragraph up through the first embodiment in this paragraph wherein X₂ is

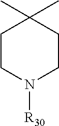

wherein R₃₀ is —H, —CH₃, —CH₂CH₃, —CH(CH₃)₂, —C(CH₃)₃, —CH₂—C₆H₅, or —CH₂—CH(CH₃)₂. An embodiment of the invention is one, any or all of prior embodiments in this paragraph up through the first embodiment in this paragraph wherein X₂ is a mixture of

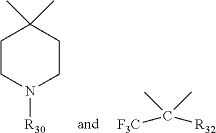

wherein R₃₀ is —H, —CH₃, —CH₂CH₃, —CH(CH₃)₂, —C(CH₃)₃, —CH₂—C₆H₅, or —CH₂—CH(CH₃)₂; and wherein R₃₂ is —C₆H₅. An embodiment of the invention is one, any or all of prior embodiments in this paragraph up through the first embodiment in this paragraph, wherein the anion exchange membrane is used in a fuel cell, an electrolyzer, a flow battery, an electrodialyzer, a waste metal recovery system, an electrocatalytic hydrogen production system, a desalinator, a water purifier, a waste water treatment system, an ion exchanger, or a CO₂ separator. An embodiment of the invention is one, any or all of prior embodiments in this paragraph up through the first embodiment in this paragraph wherein the anion exchange membrane comprises a nonporous symmetric dense film membrane, an integrally-skinned asymmetric membrane, a reinforced composite membrane, or a thin film composite membrane. An embodiment of the invention is one, any or all of prior embodiments in this paragraph up through the first embodiment in this paragraph wherein the integrally-skinned asymmetric membrane, the reinforced composite membrane, or the thin film composite membrane comprises a porous substrate material impregnated or coated with the anion exchange polymer.

A second embodiment of the invention is a system comprising an anion exchange membrane comprising an anion exchange polymer; and a hydrogen recombination catalyst dispersed in the anion exchange polymer; a cathode comprising a cathode catalyst on a first surface of the anion exchange membrane; and optionally an anode comprising an anode catalyst on a second surface of the anion exchange membrane; wherein the anion exchange polymer comprises a plurality of repeating units of formula (I)

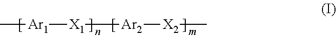

wherein Ar₁ and Ar₂ are independently selected from the group consisting of

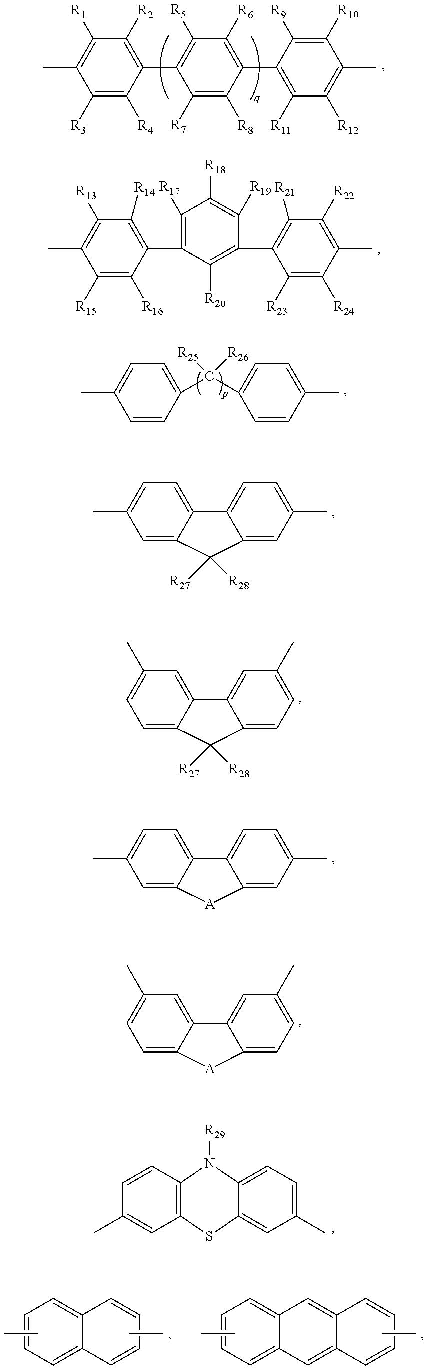

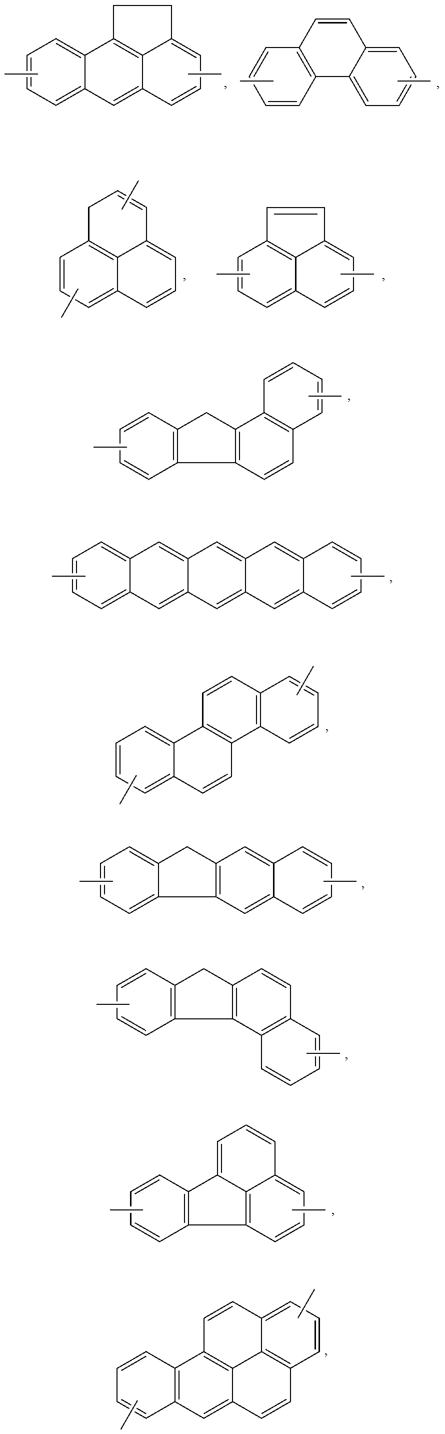

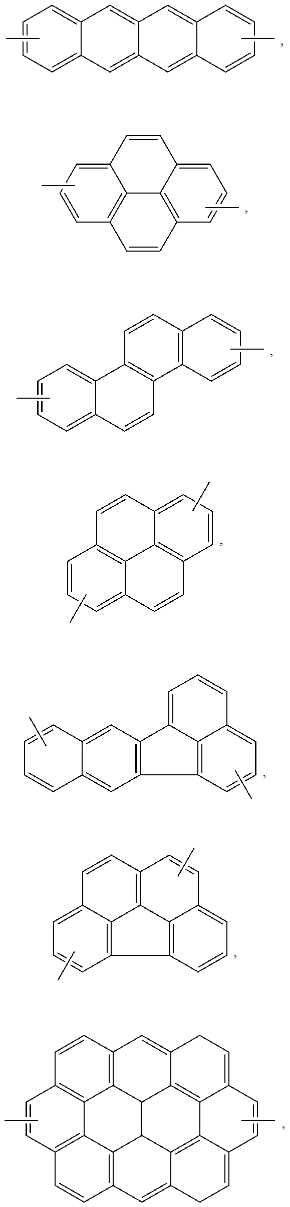

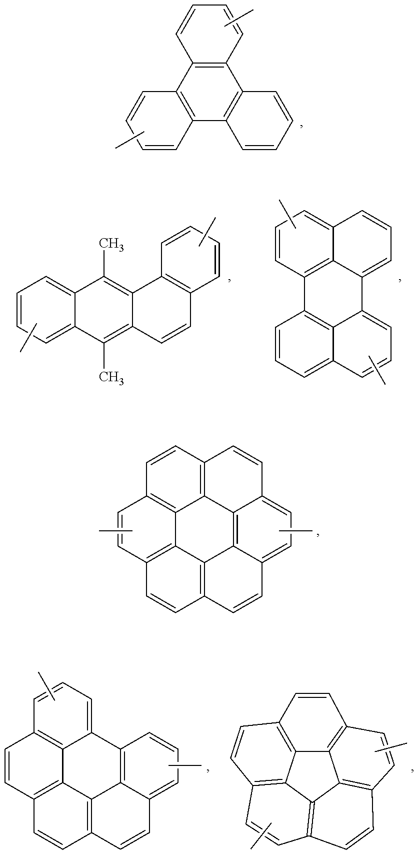

and mixtures thereof; wherein X₁ is selected from the group consisting of

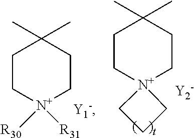

and mixtures thereof; wherein X₂ is selected from the group consisting of

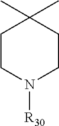

or a mixture of

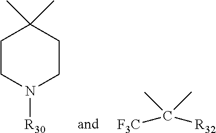

wherein Ar₁⁻ and Ar₂⁻ are the same or different from each other; wherein Y₁⁻ and Y₂⁻ are anions; wherein R₁-R₂₈ are each independently hydrogen, a halide, an alkyl group, an alkenyl group, an alkynyl group, or an aryl group, and the alkyl, alkenyl, alkynyl, or aryl groups are optionally substituted with a halide or a positively charged functional group; wherein R₂₉-R₃₁ are each independently hydrogen, an alkyl group, an alkenyl group, an alkynyl group, or an aryl group, and the alkyl, alkenyl, alkynyl or aryl groups are optionally substituted with a halide or a positively charged functional group; wherein R₃₂ is an alkyl group, an alkenyl group, an alkynyl group, or an aryl group, and the alkyl, alkenyl, alkynyl or aryl group is optionally substituted with a halide or a positively charged functional group; wherein A is O, S, or NR₁₀₀; wherein R₁₀₀ is hydrogen, an alkyl group, an alkenyl group, an alkynyl group, or an aryl group, and the alkyl, alkenyl, alkynyl, or aryl groups are optionally substituted with a halide or a positively charged functional group; wherein n is an integer from 10 to 100,000; wherein m is an integer from 5 to 50,000 and the molar ratio of n/m is in a range of 11 to 991; wherein p is 1, 2, 3, or 4; wherein q is 0, 1, 2, or 3; and wherein t is 1, 2, 3, 4, 5, or 6. An embodiment of the invention is one, any or all of prior embodiments in this paragraph up through the second embodiment in this paragraph wherein the hydrogen recombination catalyst comprises Pt, Pt supported on carbon silica, titania, or zirconia, PtCo, PtCo supported on carbon, silica, titania, or zirconia, Pd, Pd supported on carbon, silica, titania, or zirconia, PdCo, PdCo supported on carbon, silica, titania, or zirconia, Ru, Ru supported on carbon, silica, titania, or zirconia, RuCo, RuCo supported on carbon, silica, titania, or zirconia, or mixtures thereof.

An embodiment of the invention is one, any or all of prior embodiments in this paragraph up through the second embodiment in this paragraph further comprising a radical scavenger. An embodiment of the invention is one, any or all of prior embodiments in this paragraph up through the second embodiment in this paragraph wherein the radical scavenger comprises CeO₂, Ce(OH)₄, NbO₂, NbO, CeO₂/ZrO₂, CeO₂/NbO₂, TiO₂, HfO₂, Bi₂O₃, BeO, Ta₂O₅, Ce(OH)₄/ZrO₂, CeO₂—TiC, MnO, MnO₂, MnO₂/SiO₂—SO₃H, boehmite, silica-supported Cr, Co or Mn, or mixtures thereof. An embodiment of the invention is one, any or all of prior embodiments in this paragraph up through the second embodiment in this paragraph further comprising a cathode porous transport layer adjacent to the cathode; and an anode porous transport layer or an anode catalyst-coated anode porous transport layer adjacent to the second surface of the anion exchange membrane. An embodiment of the invention is one, any or all of prior embodiments in this paragraph up through the second embodiment in this paragraph wherein Ar₁ and Ar₂ are independently selected from the group consisting of

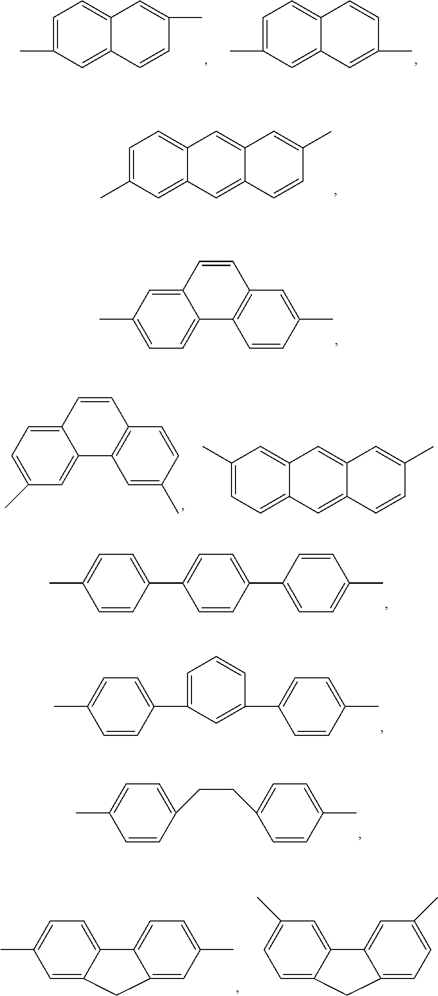

and mixtures thereof. An embodiment of the invention is one, any or all of prior embodiments in this paragraph up through the second embodiment in this paragraph wherein X₁ is

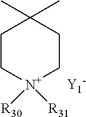

wherein R₃₀ and R³¹ are each independently —H, —CH₃, —CH₂CH₃, —CH(CH₃)₂, —C(CH₃)₃, —CH₂—C₆H₅, or —CH₂—CH(CH₃)₂; wherein Y₁⁻ is HCO₃⁻, OH⁻, I⁻, CF₃SO₃⁻, or

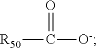

and wherein R₅₀ is —CH₃, —CF₃, CH₃CH₂—, or CH₃CH₂CH₂—; and wherein X₂ is

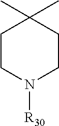

wherein R₃₀ is —H, —CH₃, —CH₂CH₃, —CH(CH₃)₂, —C(CH₃)₃, —CH₂—C₆H₅, or —CH₂—CH(CH₃)₂.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. An anion exchange membrane comprising:
an anion exchange polymer, and
a hydrogen recombination catalyst dispersed in the anion exchange polymer,
wherein the anion exchange polymer comprises a plurality of repeating units of formula (I) 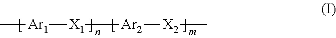
wherein Ar₁ and Ar₂ are independently selected from the group consisting of: 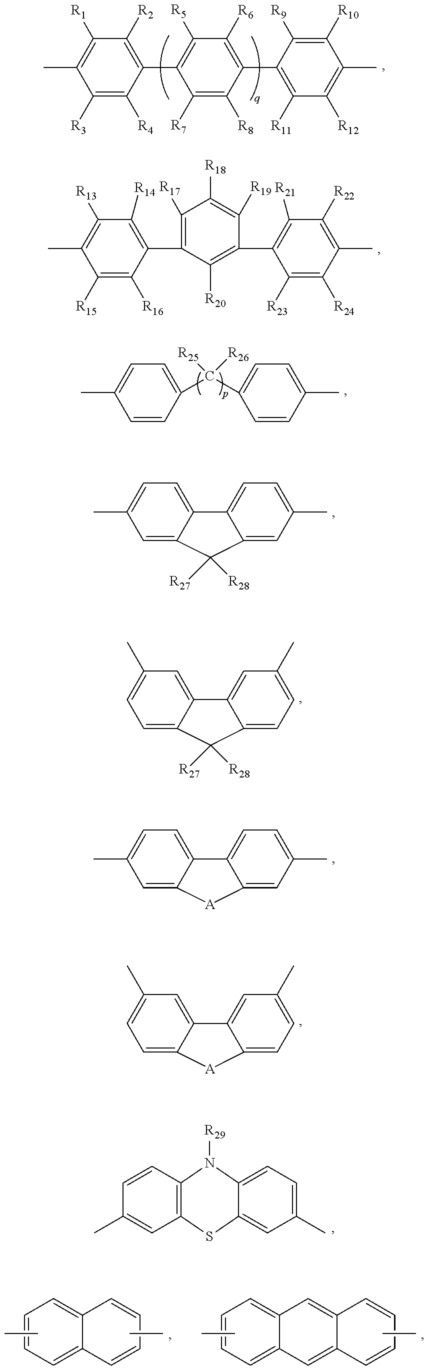 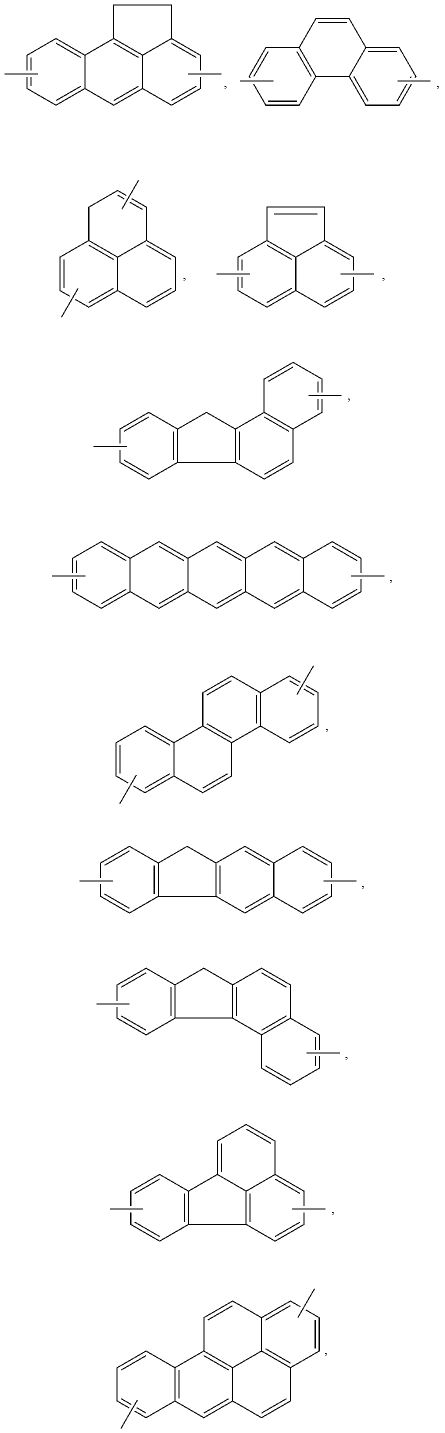 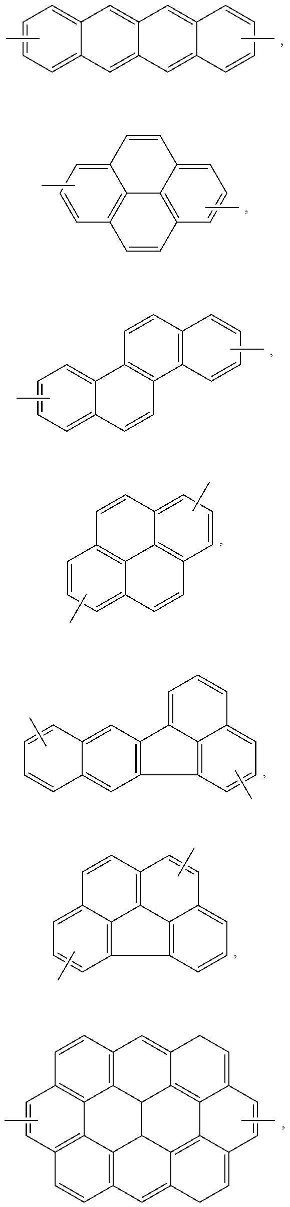 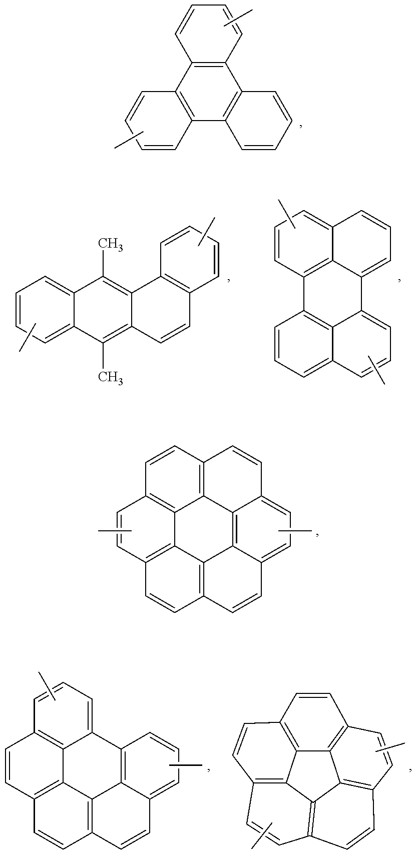
and mixtures thereof;
wherein X₁ is selected from the group consisting of: 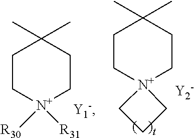
and mixtures thereof;
wherein X₂ is selected from the group consisting of: 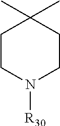
or a mixture of 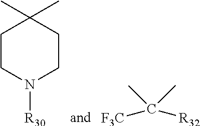
wherein Ar₁ and Ar₂ are the same or different from each other;
wherein Y₁⁻ and Y₂⁻ are anions;
wherein R₁-R₂₈ are each independently hydrogen, a halide, an alkyl group, an alkenyl group, an alkynyl group, or an aryl group, and the alkyl, alkenyl, alkynyl, or aryl groups are optionally substituted with a halide or a positively charged functional group;
wherein R₂₉-R₃₁ are each independently hydrogen, an alkyl group, an alkenyl group, an alkynyl group, or an aryl group, and the alkyl, alkenyl, alkynyl or aryl groups are optionally substituted with a halide or a positively charged functional group;
wherein R₃₂ is an alkyl group, an alkenyl group, an alkynyl group, or an aryl group, and the alkyl, alkenyl, alkynyl or aryl group is optionally substituted with a halide or a positively charged functional group;
wherein A is O, S, or NR₁₀₀;
wherein R₁₀₀ is hydrogen, an alkyl group, an alkenyl group, an alkynyl group, or an aryl group, and the alkyl, alkenyl, alkynyl, or aryl groups are optionally substituted with a halide or a positively charged functional group;
wherein n is an integer from 10 to 100,000;
wherein m is an integer from 5 to 50,000 and the molar ratio of n/m is in a range of 1:1 to 99:1;
wherein p is 1, 2, 3, or 4;
wherein q is 0, 1, 2, or 3; and
wherein t is 1, 2, 3, 4, 5, or 6.

2. The anion exchange membrane of claim 1 wherein the hydrogen recombination catalyst comprises Pt, Pt supported on carbon, silica, titania, or zirconia, PtCo, PtCo supported on carbon, silica, titania, or zirconia, Pd, Pd supported on carbon, silica, titania, or zirconia, PdCo, PdCo supported on carbon, silica, titania, or zirconia, Ru, Ru supported on carbon, silica, titania, or zirconia, RuCo, RuCo supported on carbon, silica, titania, or zirconia, or mixtures thereof.

3. The anion exchange membrane of claim 1 further comprising a radical scavenger.

4. The anion exchange membrane of claim 3 wherein the radical scavenger comprises CeO₂, Ce(OH)₄, NbO₂, NbO, CeO₂/ZrO₂, CeO₂/NbO₂, TiO₂, HfO₂, BizO₃, BeO, Ta₂O₅, Ce(OH)₄/ZrO₂, CeO₂—TiC, MnO, MnO₂, MnO₂/SiO₂—SO₃H, boehmite, silica-supported Cr, Co or Mn, or mixtures thereof.

5. The anion exchange membrane of claim 1 wherein Ar₁ and Ar₂ are independently selected from the group consisting of 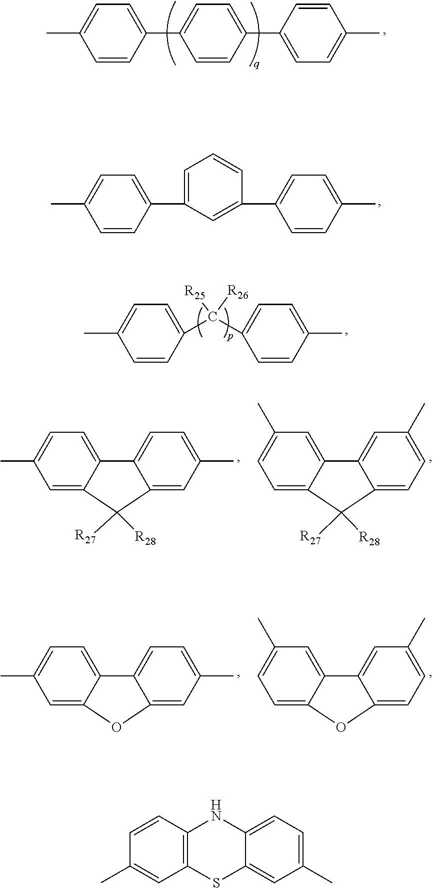
and mixtures thereof;
wherein R₂₅, R₂₆, R₂₇, and R₂₈ are each independently —H or —CH₃;
wherein p is 1 or 2; and
wherein q is 0 or 1.

6. The anion exchange membrane of claim 1 wherein Ar₁ and Ar₂ are independently selected from the group consisting of 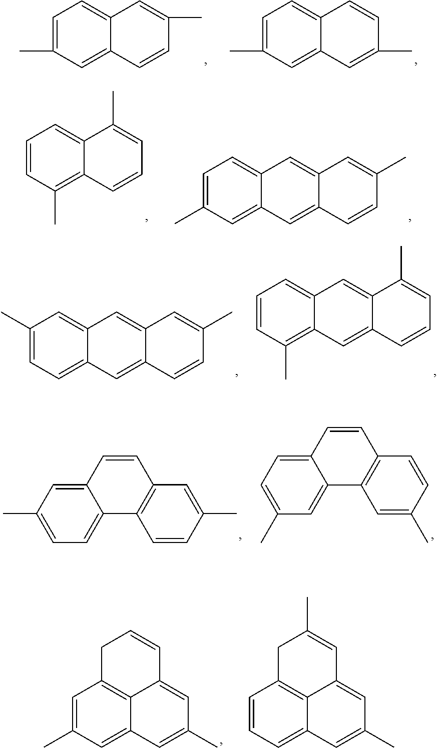
and mixtures thereof.

7. The anion exchange membrane of claim 1 wherein Ar₁ and Ar₂ are independently selected from the group consisting of 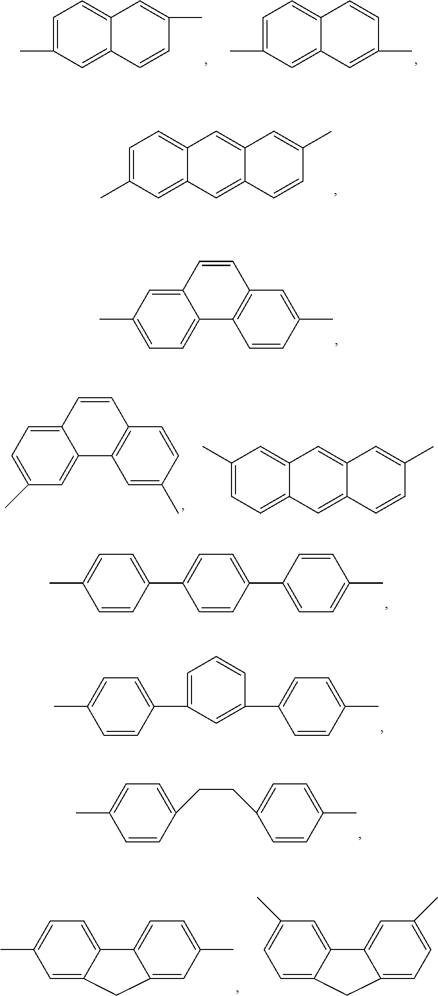
and mixtures thereof.

8. The anion exchange membrane of claim 1 wherein X₁ is 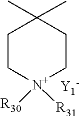
wherein R₃₀ and R₃₁ are each independently —H, —CH₃, —CH₂CH₃, —CH(CH₃)₂, —C(CH₃)₃, —CH₂—C₆H₅, or —CH₂—CH(CH₃)₂;
wherein Y₁⁻ is HCO₃⁻, OH⁻, I⁻, CF₃SO₃; or 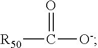
and
wherein R₅₀ is —CH₃, —CF₃, CH₃CH₂—, or CH₃CH₂CH₂—.

9. The anion exchange membrane of claim 1 wherein X₂ is 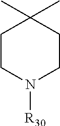
wherein R₃₀ is —H, —CH₃, —CH₂CH₃, —CH(CH₃)₂, —C(CH₃)₃, —CH₂—C₆H₅, or —CH₂—CH(CH₃)₂.

10. The anion exchange membrane of claim 1 wherein X₂ is a mixture of 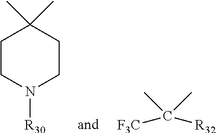
wherein R₃₀ is —H, —CH₃, —CH₂CH₃, —CH(CH₃)₂, —C(CH₃)₃, —CH₂—C₆H₅, or —CH₂—CH(CH₃)₂; and
wherein R₃₂ is —C₆H₅.

11. The anion exchange membrane of claim 1, wherein the anion exchange membrane is used in a fuel cell, an electrolyzer, a flow battery, an electrodialyzer, a waste metal recovery system, an electrocatalytic hydrogen production system, a desalinator, a water purifier, a waste water treatment system, an ion exchanger, or a CO₂ separator.

12. The anion exchange membrane of claim 1 wherein the anion exchange membrane comprises a nonporous symmetric dense film membrane, an integrally-skinned asymmetric membrane, a reinforced composite membrane, or a thin film composite membrane.

13. The anion exchange membrane of claim 12 wherein the integrally-skinned asymmetric membrane, the reinforced composite membrane, or the thin film composite membrane comprises a porous substrate material impregnated or coated with the anion exchange polymer.

14. A membrane electrode assembly, comprising:
an anion exchange membrane comprising:
an anion exchange polymer; and
a hydrogen recombination catalyst dispersed in the anion exchange polymer;
a cathode comprising a cathode catalyst on a first surface of the anion exchange membrane; and
optionally an anode comprising an anode catalyst on a second surface of the anion exchange membrane;
wherein the anion exchange polymer comprises a plurality of repeating units of formula (I) 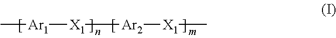
wherein Ar₁ and Ar₂ are independently selected from the group consisting of: 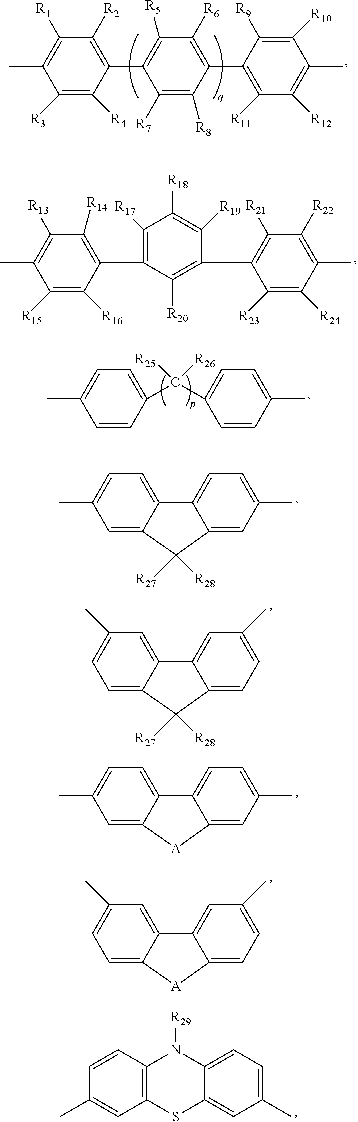 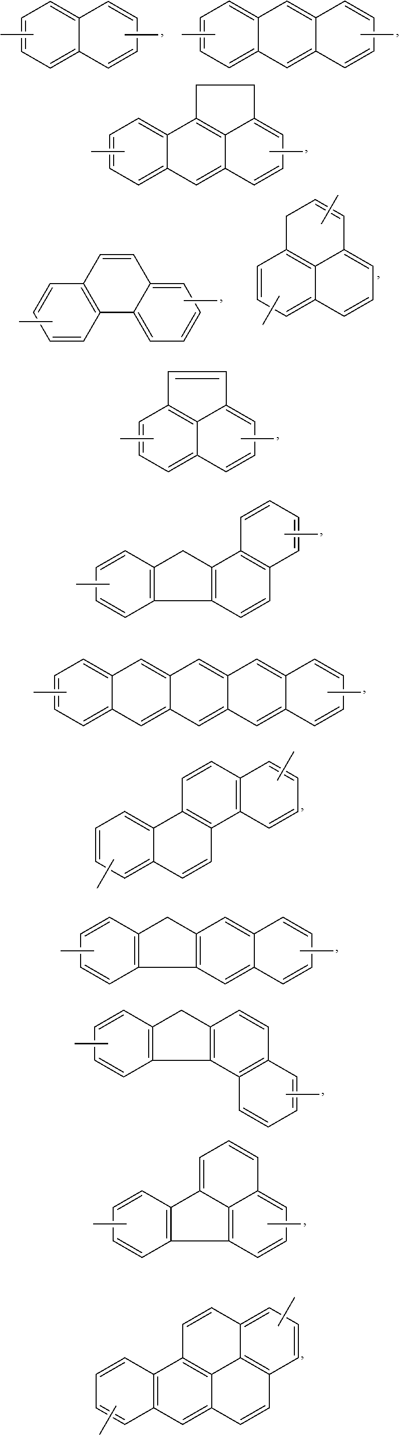 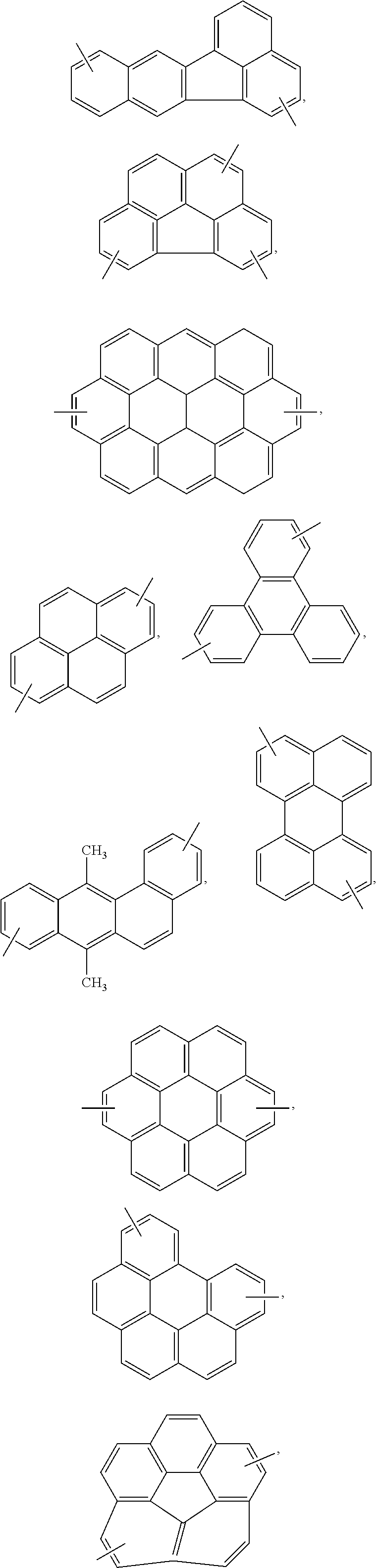
and mixtures thereof;
wherein X₁ is selected from the group consisting of: 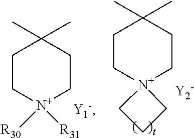
and mixtures thereof;
wherein X₂ is selected from the group consisting of: 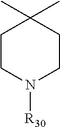
or a mixture of 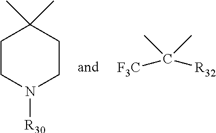
wherein Ar₁ and Ar₂ are the same or different from each other;
wherein Y₁⁻ and Y₂⁻ are anions;
wherein R₁-R₂₈ are each independently hydrogen, a halide, an alkyl group, an alkenyl group, an alkynyl group, or an aryl group, and the alkyl, alkenyl, alkynyl, or aryl groups are optionally substituted with a halide or a positively charged functional group;
wherein R₂₉-R₃₁ are each independently hydrogen, an alkyl group, an alkenyl group, an alkynyl group, or an aryl group, and the alkyl, alkenyl, alkynyl or aryl groups are optionally substituted with a halide or a positively charged functional group;
wherein R₃₂ is an alkyl group, an alkenyl group, an alkynyl group, or an aryl group, and the alkyl, alkenyl, alkynyl or aryl group is optionally substituted with a halide or a positively charged functional group;
wherein A is O, S, or NR₁₀₀;
wherein R₁₀₀ is hydrogen, an alkyl group, an alkenyl group, an alkynyl group, or an aryl group, and the alkyl, alkenyl, alkynyl, or aryl groups are optionally substituted with a halide or a positively charged functional group;
wherein n is an integer from 10 to 100,000;
wherein m is an integer from 5 to 50,000 and the molar ratio of n/m is in a range of 1:1 to 99:1;
wherein p is 1, 2, 3, or 4;
wherein q is 0, 1, 2, or 3; and
wherein tis 1, 2, 3, 4, 5, or 6.

15. The membrane electrode assembly of claim 14 wherein the hydrogen recombination catalyst comprises Pt, Pt supported on carbon silica, titania, or zirconia, PtCo, PtCo supported on carbon, silica, titania, or zirconia, Pd, Pd supported on carbon, silica, titania, or zirconia, PdCo, PdCo supported on carbon, silica, titania, or zirconia, Ru, Ru supported on carbon, silica, titania, or zirconia, RuCo, RuCo supported on carbon, silica, titania, or zirconia, or mixtures thereof.

16. The membrane electrode assembly of claim 14 further comprising a radical scavenger.

17. The membrane electrode assembly of claim 16 wherein the radical scavenger comprises CeO₂, Ce(OH)₄, NbO₂, NbO, CeO₂/ZrO₂, CeO₂/NbO₂, TiO₂, HfO₂, Bi₂O₃, BeO, Ta₂O₅, Ce(OH)₄/ZrO₂, CeO₂—TiC, MnO, MnO₂, MnO₂/SiO₂—SO₃H, boehmite, silica-supported Cr, Co or Mn, or mixtures thereof.

18. The membrane electrode assembly of claim 14 further comprising:
a cathode porous transport layer adjacent to the cathode; and
an anode porous transport layer or an anode catalyst-coated anode porous transport layer adjacent to the second surface of the anion exchange membrane.

19. The membrane electrode assembly of claim 14 wherein Ar₁ and Ar₂ are independently selected from the group consisting of 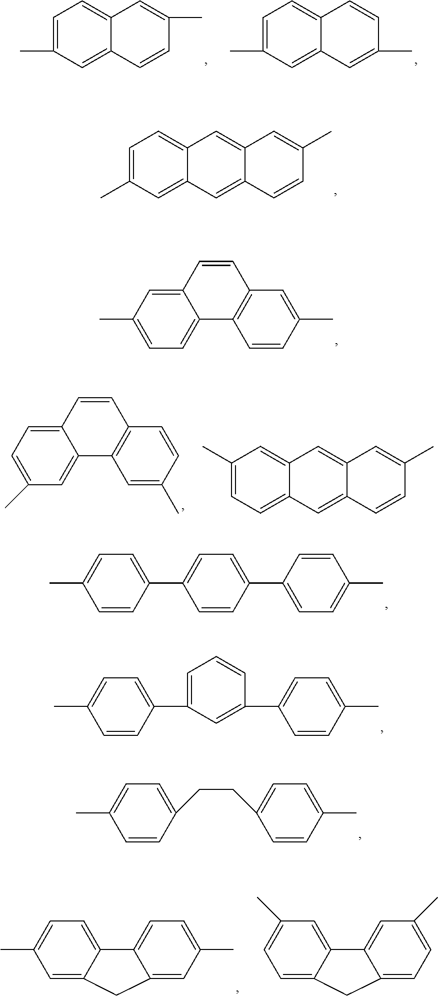
and mixtures thereof.

20. The membrane electrode assembly of claim 14 wherein X₁ is 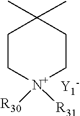
wherein R₃₀ and R₃₁ are each independently —H, —CH₃, —CH₂CH₃, —CH(CH₃)₂, —C(CH₃)₃, —CH₂—C₆H₅, or —CH₂—CH(CH₃)₂;
wherein Y₁⁻ is HCO₃⁻, OH⁻, I⁻, CF₃SO₃⁻, or 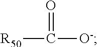
and
wherein R₅₀ is —CH₃, —CF₃, CH₃CH₂—, or CH₃CH₂CH₂—;
and wherein X₂ is 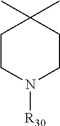
wherein R₃₀ is —H, —CH₃, —CH₂CH₃, —CH(CH₃)₂, —C(CH₃)₃, —CH₂—C₆H₅, or —CH₂—CH(CH₃)₂.
